(19) United States
(12) Patent Application Publication
(10) Pub. No.: US 2022/0416268 A1
(43) Pub. Date: Dec. 29, 2022

(54) MULTI-EJECTOR FUEL CELL SYSTEM CONFIGURATIONS

(71) Applicants: CUMMINS INC., Columbus, IN (US); Hydrogenics Corporation, MIssissauga (CA)

(72) Inventors: Richard ANCIMER, Toronto (CA); Eero TEENE, Hamilton (CA); Paolo FORTE, Maple (CA)

(21) Appl. No.: 17/670,259

(22) Filed: Feb. 11, 2022

Related U.S. Application Data
(60) Provisional application No. 63/215,089, filed on Jun. 25, 2021.

(51) Int. Cl. H01M 8/04089; H01M 8/04082

(52) U.S. Cl. CPC H01M 8/04089; H01M 8/04201

(57) ABSTRACT

The present disclosure generally relates to systems and methods comprising more than one venturi or ejector with a fuel cell or fuel cell stack.

### CROSS-REFERENCE TO RELATED APPLICATIONS

This nonprovisional application claims the benefit and priority, under 35 U.S.C. § 119(e) and any other applicable laws or statutes, to U.S. Provisional Patent Application Ser. No. 63/215,089 filed on Jun. 25, 2021, the entire disclosure of which is hereby expressly incorporated herein by reference.

### TECHNICAL FIELD

The present disclosure relates to systems and methods of operating a system comprising more than one venturi or ejector and a fuel cell or fuel cell stack.

### BACKGROUND

Vehicles and/or powertrains use fuel cells or fuel cell stacks for their power needs. The fuel cell or fuel cell stacks may be any type of fuel cell. For example, the fuel cell and/or fuel cell stack may include, but are not limited to, a phosphoric acid fuel cell (PAFC), a molten carbonate fuel cell (MCFC), a proton exchange membrane fuel cell, also called a polymer exchange membrane fuel cell (PEMFC), and a solid oxide fuel cell (SOFC).

A fuel cell or fuel cell stack may generate electricity in the form of direct current (DC) from electro-chemical reactions that take place in the fuel cell or fuel cell stack. A fuel processor converts fuel into a form usable by the fuel cell or fuel cell stack. If the fuel cell or fuel cell stack is powered by a hydrogen-rich, conventional fuel, such as methanol, gasoline, diesel, or gasified coal, a reformer may convert hydrocarbons into a gas mixture of hydrogen and carbon compounds, or reformate. The reformate may then be converted to carbon dioxide, purified and recirculated back into the fuel cell or fuel cell stack.

Fuel, such as hydrogen or a hydrocarbon, is channeled through field flow plates to the anode on one side of the fuel cell or fuel cell stack, while oxygen from the air is channeled to the cathode on the other side of the fuel cell or fuel cell stack. At the anode, a catalyst, such as a platinum catalyst, causes the hydrogen to split into positive hydrogen ions (protons) and negatively charged electrons. In the case of a polymer exchange membrane fuel cell (PEMFC), the polymer electrolyte membrane (PEM) permits the positively charged ions to flow through the PEM to the cathode. The negatively charged electrons are directed along an external loop to the cathode, creating an electrical circuit (electrical current). At the cathode, the electrons and positively charged hydrogen ions combine with oxygen to form water, which flows out of the fuel cell or fuel cell stack.

Fuel stream is exhausted from a fuel cell or fuel cell stack outlet and recirculated back to the anode through an anode inlet. The recirculation of the fuel stream exhaust back to the anode inlet includes both fuel and water. The recirculation rate is based on specified excess fuel targets such as excess fuel ratio or entrainment ratio (ER). The entrainment ratio (ER) is defined as the ratio of mass flow rate of the low pressure stream (e.g., the secondary mass flow rate) to the mass flow rate of the high pressure stream (e.g., the primary mass flow rate).

Fuel targets for a system may be specified as a minimum level of excess fuel required by the fuel cell or fuel cell stack based on the operating conditions of the fuel cell or fuel cell stack. A fuel cell or fuel cell stack may have an excess fuel level higher than the minimum level defined by the excess fuel target, but achieving that higher level may result in a high parasitic load on the fuel cell or fuel cell stack. For example, an excess fuel level higher than the minimum excess fuel level may be achieved by maintaining high fuel flow rates at the anode which may lead to pressure loss in the fuel cell or fuel cell stack. A blower and/or pump may function at a capacity proportional to the pressure loss in the fuel cell or fuel cell stack and/or to the volumetric flow rate through the blower and/or pump. A blower and/or pump may use additional power to compensate for the pressure loss. Use of additional power by the blower and/or pump may result in a high parasitic load on the fuel cell or fuel cell stack. Different system configurations may be implemented such that the system may deliver the required entrainment ratio and/or power with minimum parasitic load.

The present disclosure relates to systems and methods of operating a system comprising more than one venturi or ejector and a fuel cell or fuel cell stack. The present disclosure also relates to determining a division of labor between more than one venturi or ejectors in a series or in a parallel configuration.

### SUMMARY OF THE INVENTION

Embodiments of the present invention are included to meet these and other needs. In one aspect, described herein is a fuel cell or fuel stack system comprising an operating current density range comprising a lowest operating current density and a highest operating current density, a control valve, a first ejector comprising a first primary fuel, a first entrained fuel, a first maximum current density, a first minimum current density, and a first turn down ratio, and a second ejector comprising a second primary fuel, a second entrained fuel, a second maximum current density, a second minimum current density, and a second turn down ratio.

In one embodiment, the system further comprises a blower in a series or parallel configuration to the first or the second ejector. In some embodiments, the first ejector is in parallel or in series to the second ejector. In one embodiment, the first turn down ratio is from about 1.5 to about 8, or the second turn down ratio is in a range from about 1.5 to about 8, and the first turn down ratio is the same as the second turn down ratio. In some embodiments, the first turn down ratio is different from the second turn down ratio.

In one embodiment, the first primary fuel flows through a first primary nozzle in the first ejector and the second primary fuel flows through a second primary nozzle in the second ejector, the first turn down ratio is 2 and the second turn down ratio is 2, and the ratio of the first primary nozzle to the second primary nozzle is 2:1.

In one embodiment, the first ejector is sized to provide an entrainment ratio at the lowest operating current density of the system up to a first current density and the second ejector is sized to provide the entrainment ratio above the first current density and up to the highest operating current density.

In one embodiment, the system further comprises a by-pass valve downstream of the control valve and the by-pass valve accounts for an entrainment ratio above a by-pass valve current density and up to the highest operating current density. In some embodiments, the first ejector is sized to provide the entrainment ratio at the lowest operating current density of the system up to a first current density, and the second ejector is sized to provide the entrainment ratio above the first current density and up to the by-pass valve current density.

In one embodiment, the first primary fuel flows through a first primary nozzle in the first ejector and the second primary fuel flows through a second primary nozzle in the second ejector, the first turn down ratio is 2 and the second turn down ratio is 2, and the ratio of the first primary nozzle to the second primary nozzle is 2:1. In some embodiments, the first ejector and the second ejector together account for the entrainment ratio up to the by-pass valve current density.

In one embodiment, the mixer area ratio of the first ejector is different from the mixer area ratio of the second ejector. In some embodiment, the first ejector and the second ejector are sized based on a minimum fuel supply pressure for both the first ejector and the second ejector or the turn down ratio of the first ejector and the second ejector.

In one embodiment, the first ejector or the second ejector are sized to operate at the lowest operating current of the system. In some embodiments, the system operates only the first ejector if the first maximum current density of the first ejector is greater than a maximum operating current density of the system, and the first mixer area ratio of the first ejector is sized to not geometrically constrain the required entrainment ratio.

In one embodiment, the system operates the first ejector or the second ejector if the first maximum current density of the first ejector is lower than a maximum operating current density of the system. In some embodiments, the system operates the second ejector if current demand is equal to or more than the second minimum current density. In other embodiments, the system operates the second ejector before current demand is equal to the first maximum current density of the first ejector. In some other embodiments, the system operates the first ejector and the second ejector before current demand is equal to the second maximum current density of the first ejector. In other embodiments, the system does not operate both the first ejector and the second ejector before current demand is equal to the sum of the first minimum current density of the first ejector and the second minimum current density of the second ejector.

In another aspect, described herein is a method of operating a fuel cell or fuel stack system comprising flowing a first primary fuel through a control valve and a first ejector, flowing a first entrained fuel through the ejector, flowing a second primary fuel through the control valve and a second ejector, flowing a second entrained fuel through the ejector, and operating the first or the second ejectors. The first ejector comprises a first maximum current density, a first turn down ratio, a first mixer area ratio, and a first minimum current density, and the second ejector comprises a second maximum current density, a second turn down ratio, a second mixer area ratio, and a second minimum current density. The system comprises an operating current density range comprising a lowest operating current density and a highest operating current density.

### BRIEF DESCRIPTION OF THE DRAWINGS

These and other features, aspects, and advantages of the present invention will become better understood when the following detailed description is read with reference to the accompanying drawings, in which like characters represent like parts throughout the drawings, wherein:

FIG. 1 is a graph showing the operating curves of a system comprising a fuel cell or fuel cell stack.

FIG. 2 is a schematic showing a mechanical regulator used along with a venturi or ejector in a fuel cell stack system.

FIG. 3 is a schematic showing a proportional control valve used along with a venturi or ejector in a fuel cell stack system.

FIG. 4A is a schematic showing a small venturi or ejector in a parallel configuration with a recirculation pump or a blower.

FIG. 4B is a graph showing the operating curves of a system comprising a small venturi or ejector in a parallel configuration with a recirculation pump or a blower.

FIG. 5A is a schematic of one embodiment of a system comprising multiple venturi or ejector in a parallel configuration.

FIG. 5B is a schematic of a second embodiment of a system comprising multiple venturi or ejector in a parallel configuration.

FIG. 6A is a schematic of one embodiment of a system comprising multiple venturi or ejector in a series configuration.

FIG. 6B is a schematic of a second embodiment of a system comprising multiple venturi or ejector in a series configuration.

FIG. 7A is a graph showing the division of labor between multiple ejectors when the fuel supply pressure is about 30 bara.

FIG. 7B is a graph showing the division of labor between multiple ejectors when the fuel supply pressure is about 20 bara.

FIG. 7C is a graph showing the division of labor between multiple ejectors when the fuel supply pressure is about 14 bara.

### DETAILED DESCRIPTION

The present disclosure relates to systems and methods of operating a system comprising more than one venturi or ejector in a series or in a parallel configuration. The present disclosure relates to using and sizing the more than the more than one venturi or ejectors comprised in a fuel cell system. The present disclosure also relates to determining and/or implementing a division of labor between more than the more than one venturi or ejectors.

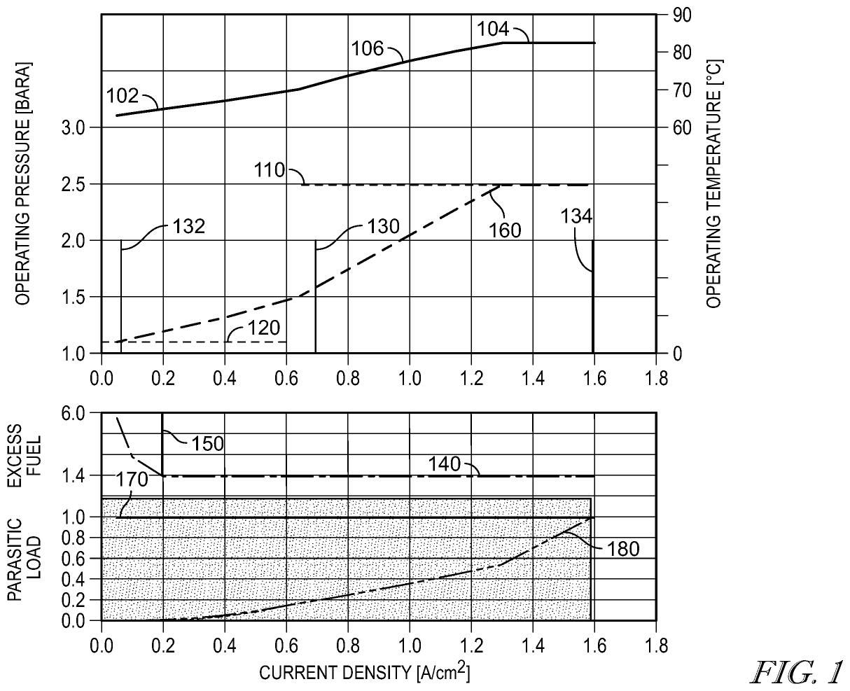

One embodiment of the requirements of the present operating system (e.g., a fuel cell system) comprising a fuel cell or fuel cell stack is shown in FIG. 1. The fuel cell and/or fuel cell stack may include, but are not limited to, a phosphoric acid fuel cell (PAFC), a molten carbonate fuel cell (MCFC), a proton exchange membrane fuel cell, also called a polymer exchange membrane fuel cell (PEMFC), and a solid oxide fuel cell (SOFC). The operating pressures and the associated operating temperatures are shown as a function of current density. A fuel cell or fuel cell stack may be required to operate within a pressure range known as anode inlet manifold pressure (P_{AIM}).

The highest anode inlet manifold pressure of a fuel cell or fuel cell stack (P_{AIM_HI}) is denoted by 110. The lowest anode inlet manifold pressure of a fuel cell or fuel cell stack (P_{AIM_LO}) is denoted by 120. The range 160 between 110 and 120 indicates the target anode inlet manifold pressure range. In some embodiments, the target temperature of the system may range from a low fuel supply operating temperature (T_{CV_LO}) 102 to a high fuel supply operating temperature (T_{CV_HI}) 104.

In one embodiment, it is critical to operate the fuel cell or fuel cell stack at a pressure that ranges from about or approximately the highest anode inlet manifold pressure (P_{AIM_HI}) 110 to about or approximately the lowest anode inlet manifold pressure (P_{AIM_LO}) 120 when the fuel cell or fuel cell stack is operating above a critical current density (I_{_LO_CR}) 130. In some embodiments, the critical current density (I_{_LO_CR}) 130 may be at about 0.7 A/cm². In other embodiments, the critical current density (I_{_LO_CR}) 130 may be at about 0.6 A/cm². In some further embodiments, the critical current density (I_{_LO_CR}) 130 may be higher or lower than 0.7 A/cm², such as ranging from about 0.5 A/cm² to about 0.9 A/cm², including every current density comprised therein.

In one embodiment, the fuel cell or fuel cell stack may be operating at high current density range such as from about 1.3 A/cm² to about 2.0 A/cm², or about 1.3 A/cm² to about 1.6 A/cm², or about 1.0 A/cm² to about 1.6 A/cm². In some embodiments, operating the fuel cell or fuel cell stack at high current densities (e.g., at about 1.6 A/cm²) with pressures and temperatures different from the optimal target operating pressure and temperature may lower the efficiency of the fuel cell or fuel cell stack. Doing so may also result in damage to the fuel cell or fuel cell stack because of MEA degradation (e.g., due to starvation, flooding and/or relative humidity effects). In some embodiments, there may be more flexibility in the fuel cell or fuel cell stack operating pressure and temperature when the fuel cell or fuel cell stack is operating below the critical current density (I_{_LO_CR}) 130. The present operating system comprising the fuel cell or fuel cell stack can operate at a minimum current density (i_{MIN}) 132 and a maximum current density (i_{MAX}) 134.

In one embodiment, the present system comprising a fuel cell or fuel cell stack may operate in a functional range that may be different than that indicated by the curve 160 in FIG. 1. In some embodiments, the operating system may function at higher pressures (e.g., highest anode inlet manifold pressure (P_{AIM_HI}) 110) or at a current density as low as the critical current density (I_{_LO_CR}) 130. For example, the present system might extend steady state operation at about 2.5 bara all the way down to the critical current density (I_{_LO_CR}) 130. Pressure measurements in bara refer to the absolute pressure in bar.

In one embodiment, excess fuel may be provided at the anode inlet to avoid fuel starvation towards the anode outlet. The water content of the anode inlet stream or the relative humidity of the inlet stream may impact the performance and health of the fuel cell. For example, low inlet humidity may lead to a drier membrane electrode assembly (MEA), resulting in reduced performance. Low inlet humidity may also induce stresses that can lead to permanent damage to the membrane electrode assembly (MEA). High humidity levels may lead to flooding within the fuel cells, which can induce local starvation and/or other effects that may reduce fuel cell performance and/or damage the membrane electrode assembly (MEA). In some embodiments, there may be an optimal inlet relative humidity range in which fuel cell performance is improved and membrane electrode assembly (MEA) degradation rate is minimized For example, the fuel cell can achieve optimal performance when the anode inlet gas relative humidity levels is in the range of about 30% to about 35%.

In one embodiment, under normal operating conditions, the source of the excess fuel and water content in a fuel cell may be from recirculated anode gas. The composition of recirculated flow in the operating system is dependent on that of anode gas outlet. In some embodiments, the anode outlet gas may be saturated with water at a given anode gas outlet temperature and pressure. Thus, the composition of the recirculated flow may vary and should be taken into account when determining the required recirculation flow to meet the inlet anode gas excess fuel or relative humidity targets.

The required level of recirculation flow rate can be set by either the need for excess fuel, or for increased water content, whichever calls for higher recirculation flow. The required recirculation flow can be expressed as the target entrainment ratio (ER). Alternatively, a target effective excess fuel ratio or a minimum required fuel ratio may account for either the need for excess fuel, or the inlet anode water content. ‘Excess fuel ratio’ may be used to represent the required composition derived from the recirculation flow to meet the anode inlet gas requirement. The anode gas requirement may be the more stringent of excess fuel ratio or relative humidity requirements of the fuel cell system.

The minimum required excess fuel ratio as a function of current density is indicated by the line 140. Excess fuel ratio (λ) or the anode stoichiometry ratio is defined as the ratio of anode inlet fuel flow rate to the fuel consumed in the fuel cell or fuel cell stack. In some embodiments, the system requires a fuel amount at or above the minimum required fuel ratio level. In other embodiments, the operating system may require a target water or humidity level, which may affect the excess fuel ratio (λ) The excess fuel ratio (λ) may be flat across the system operating range except at low current densities, such as a current density at or below an excess fuel ratio current density threshold (i_{_λ_THV}) 150 or the excess fuel ratio (λ) may change with a change in the current density. In some embodiments, the excess fuel ratio (λ) above the excess fuel ratio current density threshold (i_{_λ_THV}) 150 may be range from about 1.3 to about 1.9, including any ratio comprised therein. In one preferable embodiment, the excess fuel ratio (λ) above the excess fuel ratio current density threshold (i_{_λ_THV}) 150 may be about 1.4 or about 1.6.

In some embodiments, the excess fuel ratio current density threshold (i_{_λ_THV}) 150 of the present system may be at or about 0.2 A/cm². In other embodiments, the excess fuel ratio current density threshold (i_{_λ_THV}) 150 may be at a different current density. For example, the excess fuel ratio current density threshold (i_{_λ_THV}) 150 may range from about 0.05 A/cm² to about 0.4 A/cm², including any current density comprised therein. In one preferable embodiment, the excess fuel ratio current density threshold (i_{_λ_THV}) 150 may be about 0.1 A/cm² or about 0.2 A/cm². The excess fuel ratio current density threshold (i_{_λ_THV}) 150 may depend on the operating conditions of the fuel cell or fuel cell stack.

In one embodiment, if the fuel cell or fuel cell stack is operating below the excess fuel ratio current density threshold (i_{_λ_THV}) 150, a minimum volumetric flow rate may be maintained through the anode to ensure that any liquid water that might form in the fuel cell or fuel cell stack may be flushed out of the fuel cell or fuel cell. In some embodiments, at low flow rates (e.g., below about 0.2 A/cm² or below about 0.1 A/cm²), there may be flooding in the fuel cell. In other embodiments, if the minimum volumetric flow rate is below the excess fuel ratio current density threshold (i_{_λ_THV}) 150, the rate of fuel cell or fuel cell stack degradation may increase.

In one embodiment, a venturi or ejector may be used in the present system. The venturi or ejector may be sized, such that the operating system may not require the assistance of a recirculation pump, such as a blower, at certain current densities. Absence of usage of the blower may result in a decrease in parasitic load, as shown by the curves 170 and 180 of FIG. 1. The curve 170 shows the fraction of flow that is delivered by the blower and/or recirculation pump without a venturi or ejector. The curve 180 shows the corresponding parasitic load. In some embodiments, the parasitic load may increase with an increase in current density, as shown by the curve 180, because the blower and/or recirculation pump may function at a capacity proportional to the pressure loss and the required recirculation flow rate in the fuel cell or fuel cell stack.

In some embodiments, a fuel cell or fuel cell stack may be initially operating at high current density, at high operating temperatures and pressures such that the fuel cell load under this initial operating condition is high. The fuel cell load is defined as:

Load=stack power=current×fuel cell or fuel cell stack voltage=current density×fuel cell area×fuel cell or fuel cell stack voltage

In some embodiments, the fuel cell or fuel cell stack is in a load shedding state when the load demand for power is rapidly reduced or shed requiring the fuel cell or fuel cell stack to reduce the current delivered.

In one embodiment, during transient operations in a fuel cell or fuel cell stack, the operating pressure in the fuel cell or fuel cell stack may change based on the changes in the fuel cell or fuel cell stack temperature indicated by the curve 106. For example, during load shedding, the transient operating pressure (P_{AIM_TRS}) may be greater than the steady state operating pressure (P_{AIM_SS}). In some embodiments, the transient operating pressure (P_{AIM_TRS}) may equal the highest anode inlet manifold pressure (P_{AIM_HI}) 110 even at low current densities. During load acceptance, the rate of increase in current density is limited, and the steady state operating pressure (P_{AIM_SS}) may equal the anode inlet manifold pressure (P_{AIM}).

In one embodiment, the operating pressure of a fuel cell or fuel cell stack indicated by the curve 160 may optimize the balance between enabling efficient fuel cell or fuel cell stack operation and the parasitic load required to operate at the chosen operating pressure (e.g., the parasitic load of an air compressor, a blower, and/or a pump). In some embodiments, the operating temperature indicated by the curve 106, operating pressure indicated by the curve 160, and/or excess air ratio may maintain a target relative humidity (RH) for the fuel cell or fuel cell stack operation. In other embodiments, the operating temperature indicated by the curve 106, operating pressure indicated by the curve 160, and/or excess air ratio may be determined by targeting a specific value for the relative humidity (RH) at the cathode.

The excess air ratio is defined similarly to excess fuel ratio, but refers to the cathode side flow (i.e., excess O₂ in the air). The combination of excess air ratio, pressure and temperature are used together to control humidity on the cathode side (which in turn impacts water content on the anode (H₂) side. In one embodiment, temperature, pressure, and excess air ratio that vary with current density may be used to control humidity. In some embodiments, excess air ratio is about 2.0. In other embodiments, excess air ratio is about 1.7 to about 2.1. In some other embodiments, excess air ratio is about 1.8 to about 1.9 under pressurized operation. Excess air ratio may increase to below a threshold current to keep volumetric flow rate high enough to prevent flooding in the fuel cell or fuel cell stack.

In some embodiments, the target relative humidity (RH) may be maintained by using a humidification device in combination with the operating pressure and operating temperature. For example, a humidification device may be used on the cathode side of a fuel cell or fuel cell stack. In other embodiments, if the target relative humidity (RH) and the target operating pressure for the fuel cell or fuel cell stack are specified, the target temperature for the fuel cell or fuel cell stack operation may be determined.

In one embodiment, a system comprising a fuel cell or fuel cell stack may comprise a control valve. In some embodiments, the control valve may be a mechanical regulator (e.g., a dome regulated mechanical regulator), a proportional control valve, or an injector. In other embodiments, the control valve may comprise an inner valve, coil, a solenoid, or a different mechanical element that controls the opening or closing of the control valve.

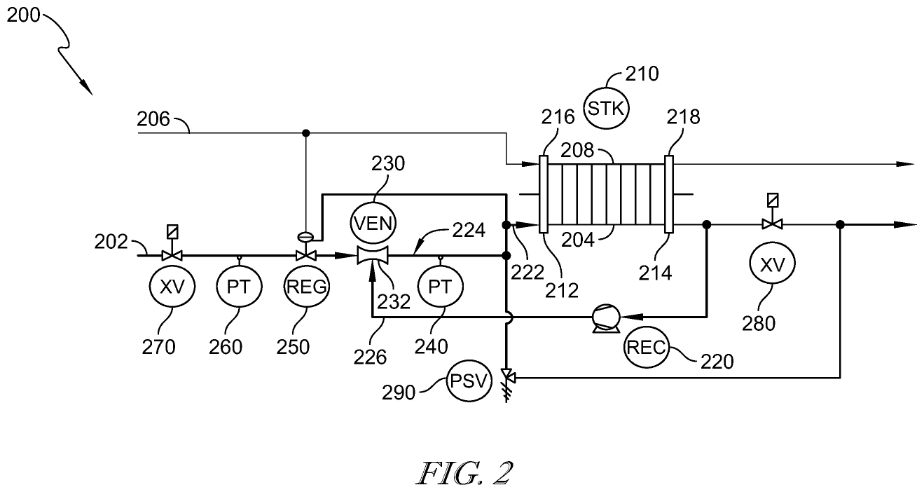

FIG. 2 illustrates one embodiment of an operating system 200 comprising a fuel cell stack 210, a mechanical regulator 250, a recirculation pump or blower 220 in series or in parallel to the fuel cell stack 210, an exhaust valve 280, a shut off valve 270, a pressure transfer valve 290, one or more pressure transducers 240/260, and a venturi or ejector 230. In some embodiments, the present system 200 may comprise one or more fuel cell stacks or one or more fuel cells. In other embodiments, there may also be one or multiple valves, sensors, compressors, regulators, blowers, injectors, ejectors, and/or other devices in series or in parallel with the fuel cell stack 210.

In one embodiment of the present system 200, the anode inlet stream 222, flows through the anode 204 end of the fuel cell stack 210. Typically, the anode stream may be a mixture of fresh fuel (e.g., H₂) and anode exhaust (e.g., H₂ fuel and/or water). Conversely, oxidant 206 (e.g., air, oxygen, or humidified air) may flow through the cathode end 208 of the fuel cell stack 210.

In one embodiment, a mechanical regulator 250 may be used to control the flow of fresh fuel 202 also referred to as primary flow, primary mass flow, primary fuel, or motive flow to the anode 204. The pressure differential between the gas streams (e.g. fuel 222 and air 206) at the anode 204 and the cathode 208 may provide an input signal to a controller in the mechanical regulator 250. The controller of the mechanical regulator 250 may determine the flow of fuel 222 through the anode inlet 212 at the anode 204.

In some embodiments, the input signal from the anode and/or cathode of the fuel cell or fuel cell stack may be a physical signal. In other embodiments, the input signal may be a virtual or an electronic signal. In yet further embodiments, the signal may be any type of communicative or computer signal known in the art.

In one embodiment, the primary fuel flow rate or primary flow rate may be controlled to match the fuel consumption in the fuel cell stack 210 based on the operating pressure (e.g., anode pressure) being used as an intermediary signal. In some embodiments, the pressure in the anode 204 may stabilize when fuel consumption matches the fresh fuel feed at the anode 204 assuming that all other parameters are equal. Since the functioning of the mechanical regulator 250 is based on the pressure differential between the anode 204 and cathode 208, a target pressure differential needs to be maintained when using a mechanical regulator 250. In some embodiments, the pressure at the cathode 208 is controlled and/or maintained at a target level via cathode side controls.

In one embodiment, a mechanically regulated approach, such as by employing actuators, may use the pressure signals from cathode/air inlet 216 to control air mass flow and maintain the appropriate pressure on the cathode 208 side of the fuel cell stack 210. In some embodiments, pressure signals from cathode 208 side are inputs to the mechanical regulator 250. In some embodiments, the anode 204 side mass flow and anode 204 side pressure may be controlled by using the pressure signals from cathode 208 side and measuring one or more anode 204 side conditions.

In one embodiment, the pressure signals from cathode 208 side may change the position of a valve in the mechanical regulator 250 to control mass flow through the mechanical regulator 250 and maintain the target pressure differential between the anode 204 and the cathode 208. In other embodiments, the input signal that acts on the mechanical regulator 250 is effectively a pressure differential that acts on a diaphragm or other parts of the mechanical regulator 250. No other direct measurement of the pressure differential must be undertaken. For example, the single point pressure at the anode 204 may be calculated to be the cathode 208 side pressure plus the pressure differential between the gas streams at the anode 204 and the cathode 208. Single point pressure may be absolute pressure or gauge pressure.

In one embodiment, the venturi or ejector 230 may draw a secondary flow 226 also referred to as secondary mass flow, entrainment flow, or recirculation flow, using a flow pressure across the anode gas recirculation (AGR) loop 224. In some embodiments, as discussed later, the venturi or ejector 230 may take advantage of the available excess exergy from the higher pressure primary flow to draw in the secondary flow 226, working against the pressure losses through the AGR loop 224. In some embodiments, the AGR loop 224 may include the venturi or ejector 230, fuel cell stack 210, a secondary inlet 232 in a suction chamber in the venturi or ejector 230, and/or other piping, valves, channels, manifolds associated with the venturi or ejector 230 and/or fuel cell stack 210. In other embodiments, the recirculation pump or blower 220 may increase or decrease the differential pressure across the AGR loop 224.

In one embodiment, the system 200 may require a target water or humidity level, which may drive the saturated secondary flow 226. The saturated secondary flow 226 may then drive the primary flow 202, such that the target excess fuel ratio (λ) may be dependent on the target water or humidity level.

In one embodiment, the recirculation pump or blower 220 may be used to achieve the excess fuel ratio. In some embodiments, the recirculation pump or blower 220 may operate across the entire operating range (current density) of the fuel cell stack 210. In other embodiments, the parasitic load of the recirculation pump or blower 220 may be substantial. In one embodiment, a large recirculation pump or blower 220 may be required to provide the power to achieve the excess target fuel ratio. In some embodiments the use of the recirculation pump or blower 220 may be inefficient and expensive. In some embodiments, operating characteristics of a recirculation pump or blower 220 may be distinct from a venturi or ejector 230.

In one embodiment, the pressure lift capability of the recirculation pump or blower 220 (ΔP_{_BLWR}) is function of the flow through the recirculation pump or blower 220 (Q), the blower speed (N), and the density of the flow composition (ρ). In some embodiments, the pressure lift of the recirculation pump or blower 220 (ΔP_{_BLWR}) may be limited by power draw limits and/or speed limit of the system 200/300. In one embodiment, when the recirculation pump or blower 220 is not spinning or under other system 200/300 stall conditions, the recirculation pump or blower 220 may act as a restriction in the AGR loop.

ΔP_{_BLWR}=ƒ(Q,N,ρ)

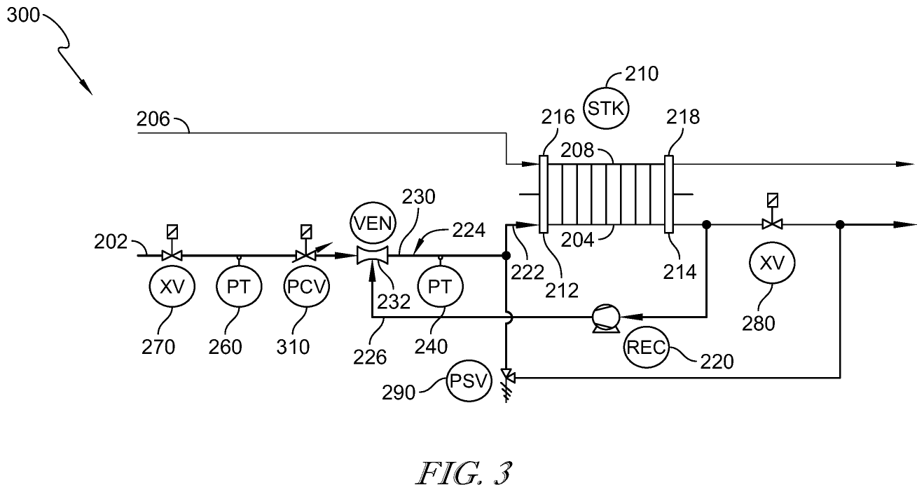

In one embodiment, as illustrated in the operating system 300 shown in FIG. 3, a proportional control valve 310 may be used instead of a mechanical regulator 250. A proportional control valve 310 is electronically controlled and may provide more flexibility in controlling the single point pressure at the anode 204 than mechanical regulator 250. In one embodiment, the proportional control valve 310 may be used to control the primary flow in an operating system 300. In other embodiments, an injector (not shown) may be used instead of a proportional control valve 310.

For example, the proportional control valve 310 may beneficially allow for active management of the differential pressure, may avoid droop issues, and/or provide flexibility in operating the fuel cell stack 210 under different operating conditions. Illustrative operating conditions may include, but are not limited to operating current density, operating pressure, operating temperature, operating relative humidity, fuel supply pressure, fuel supply temperature, required secondary flow, entrainment ratio, parasitic load limitations, power needs, pressure loses in the AGR loop 224, venturi or ejector 230 performance and/or efficiency, recirculation pump or blower 220 performance and/or efficiency, fuel density, purge flow, and choked or unchoked (e.g., not choked) flow conditions.

The turn down ratio of a system 200/300 is defined as the ratio of the maximum capacity of the venturi or ejector 230 to the minimum capacity of the venturi or ejector 230. In one embodiment, the venturi or ejector 230 may draw the recirculation flow 226 using a primary flow exergy. The turn down ratio characterizes the range over which the venturi or ejector 230 can deliver the required excess fuel ratio to the fuel cell stack 210. In one embodiment, the present operating system 200/300 may be designed to maximize the venturi or ejector 230 turn down ratio. Consequently, maximizing the turn down ratio of the venturi or ejector 230 also works to minimize the size and parasitic load associated with the recirculation pump or blower 220. In some embodiments, the venturi or ejector 230 may be required to operate and/or perform robustly to deliver the required primary flow 202 at the required excess fuel ratio.

In one embodiment, a fuel supply system may supply fuel at a fuel supply pressure (P_{CV}) and a fuel supply temperature (T_{CV}). In some embodiments, the sizing pressure (P_{_CV_MIN}) may be the minimum inlet pressure at a control valve such as the proportional control valve 310 or mechanical regulator 250 or injector. In other embodiments, fuel sizing pressure (P_{_CV_MIN}) may be the pressure at the inlet of a control valve under empty pressure conditions (P_{EMPTY}).

In one embodiment, the primary flow 202 may pass through the control valve and enter the venturi or ejector 230 through a primary nozzle at a primary nozzle inlet pressure (P_{O}) and a primary inlet temperature (T_{O}). In other embodiments, the secondary flow 226 may enter the venturi or ejector 230 through a secondary inlet 232 in a suction chamber at a secondary inlet pressure (P_{S}) and a secondary inlet temperature (T_{S}).

In one embodiment, the venturi or ejector 230 may have exergy available in primary flow to induce the anode gas recirculated flow as the secondary flow 226 in the venturi or ejector 230. In some embodiments, the stack pressure (ΔP_{STACK}) is the pressure loss through the AGR loop 224. The secondary flow 226 may be lifted against the stack pressure (ΔP_{STACK}).

In one embodiment, the pressure lift (ΔP_{LIFT}) is the pressure required to overcome the pressure loses in the AGR loop 224 (ΔP_{STACK}). In some embodiments, the pressure lift (ΔP_{LIFT}) may be dominated by the pressure losses through the fuel cell stack 210 or any other component of the AGR loop 224. In some embodiments, pressure losses may be proportional to volumetric flow rate through one or more manifolds and/or channels in the AGR loop 224. In other embodiments, the volumetric flow 222 at anode inlet 212 may include a mixture of the fresh fuel 202 and the recirculation flow 226.

In one embodiment, the secondary inlet pressure (P_{S}) may depend on the anode inlet manifold pressure (P_{AIM}) of the fuel cell or fuel cell stack 210 and the pressure loses in the AGR loop 224 (ΔP_{STACK}) or the required pressure lift (ΔP_{LIFT}).

P_{S}=P_{AIM}−ΔP_{LIFT}

In one embodiment, the amount of secondary flow 226 that can be entrained is dictated by the boundary conditions of system 200/300 and the efficiency of the venturi or ejector 230. In some embodiments, the boundary conditions may be the primary nozzle inlet pressure (P_{O}), the secondary inlet pressure (P_{S}), the anode inlet manifold pressure (P_{AIM}) of the fuel cell or fuel cell stack 210, and/or secondary flow 226 composition. In some embodiments, the secondary flow 226 from the anode outlet 214 to the venturi or ejector inlet 232 is an adiabatic process. In other embodiments, the primary inlet temperature (T_{O}) and the secondary inlet temperature (T_{S}) of the venturi or ejector 230 may affect secondary flow 226.

In one embodiment, as described earlier, above a certain critical current density (I_{_LO_CR}) 130, the system 200/300 is required to operate in the target anode inlet manifold pressure range indicated by the curve 160 in FIG. 1. In some embodiments, the primary inlet pressure (P_{O}) decreases proportionally with a decrease in primary fuel demand, until the primary nozzle is no longer choked (unchoked). In other embodiments, if the primary nozzle is unchoked, the rate of decrease of the primary inlet pressure (P_{O}) may be non-linear and/or sensitive to downstream pressure such as the secondary inlet pressure (P_{S}). In other embodiments, the primary inlet pressure (P_{O}) may decrease as the primary inlet temperature (T_{O}) decreases.

In one embodiment, the primary inlet temperature (T_{O}) may be equal to the fuel supply temperature (T_{CV}). In some embodiments, the primary inlet temperature (T_{O}) may affect the primary flow 202. In some embodiments, the system 200/300 may have a target mass flow rate. In other embodiments, the secondary inlet temperature (T_{S}) may influence the secondary flow 226 through geometric constraints of the secondary inlet 232 and/or the venturi or ejector 230. In some other embodiments, thermodynamic constraints and/or venturi or ejector 230 efficiency may influence the secondary flow 226.

In one embodiment, the venturi or ejector 230 is sensitive to the primary nozzle inlet pressure (P_{O}), the backpressure, and the required pressure lift (ΔP_{LIFT}). In some embodiments, the backpressure may be exit pressure of the venturi or ejector 230 (P_{C}) or the anode inlet manifold pressure (P_{AIM}). In other embodiments, if there are no pressure losses to the anode inlet manifold from the venturi or ejector 230 outlet, the exit pressure at the venturi or ejector 230 (P_{C}) may be equal to the anode inlet manifold pressure (P_{AIM}). In some embodiment, the primary nozzle inlet pressure (P_{O}) may be a function of the current density (i) in the system 200/300.

P_{O}=ƒ(i)

In one embodiment, the entrainment ratio (ER) is a measure of the performance and/or capability of the venturi or ejector 230 and may be sensitive to the primary nozzle inlet pressure (P_{O}), the backpressure (e.g., P_{C}, P_{AIM}) and/or the pressure lift (ΔP_{LIFT}). In one embodiment, as backpressure (e.g., P_{C}, P_{AIM}) increases, the venturi or ejector 230 may change from being double choked (with a stable entrainment ratio), to being in a transitioning condition (with a decreasing entrainment ratio), to having a reverse flow. Reverse flow in the venturi or ejector 230 may be undesirable as reverse flow indicates no fuel recirculation through the AGR loop 224. In some embodiments, the venturi or ejector 230 may need to offset pressure losses through the fuel cell or fuel cell stack 210 (ΔP_{STACK}), while operating against the backpressure (e.g., P_{C}, P_{AIM}).

In one embodiment, the reversible entrainment ratio (RER) or the reversible portion of the entrainment ratio (ER) based on the thermodynamic limits, is defined as:

RER=−Δ_{χ_M}/Δ_{χ_S}

Δ_{χ_M} is the motive flow exergy and Δ_{χ_S} is the entrained flow exergy.

In one embodiment, the venturi or ejector 230 may be sized such that the venturi or ejector 230 may be able to support the entrainment ratio (ER) at high current densities. In some embodiments, such sizing of the venturi or ejector 230 may increase the parasitic savings by decreasing the size of the recirculation pump or blower 220 used in the system 400.

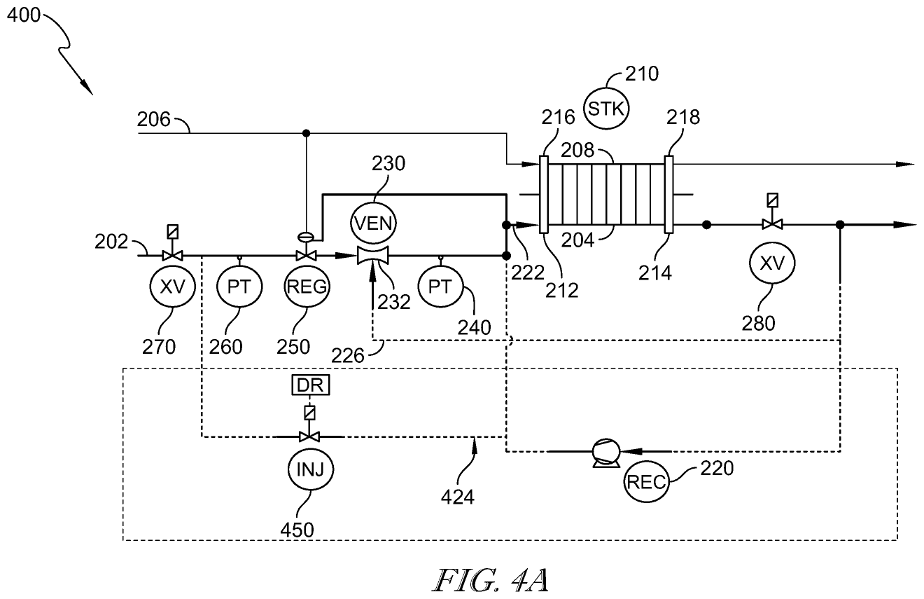

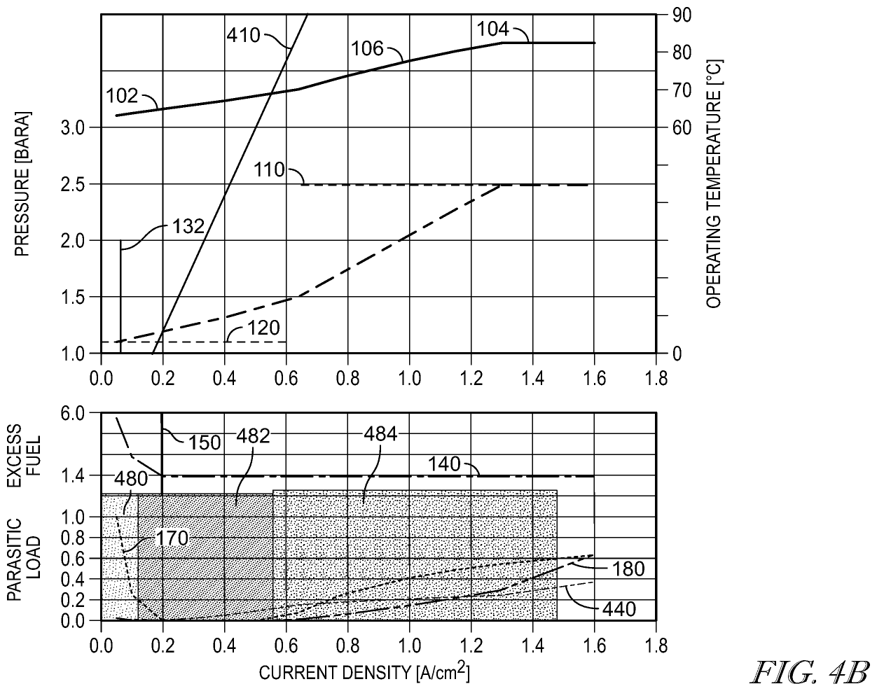

In one embodiment, as shown in FIG. 4A, a downsized or small venturi or ejector 230 may be used in parallel with a recirculation pump or blower 220 supported fueling path 224. In some embodiments, there may be a by-pass valve 450 upstream or downstream of the control valve such as the mechanical regulator 250. In other embodiments, the system 400 may comprise a proportional control valve or an injector instead of the mechanical regulator 250. In some other embodiments, the by-pass valve 450 may be a mechanical regulator, a proportional control valve or an injector.

In one embodiment, the venturi or ejector 230 may be downsized to meet the choked primary flow condition at and above the excess fuel ratio current density threshold (i_{_λ_THV}) 150. In some embodiments, this may enable robust operation of the system 400 across the entire operating range. In other embodiments, the empty pressure (P_{EMPTY}) that could be supported by the system may be a limitation. In some embodiments, the system may be able to support a high empty pressure (P_{EMPTY}) such about 40 bara or higher.

In one embodiment, a variable fuel supply pressure (P_{CV}) may be used in combination with the downsized venturi or ejector 230. In some embodiments, the operating range of the system 400 may be extended down to zero under conditions when the fuel supply pressure (P_{CV}) is greater than a minimum fuel supply pressure (P_{_CV_MIN}). In other embodiments, the system may need to open the by-pass valve if the fuel supply pressure (P_{CV}) drops below the required level to put full flow through the primary nozzle. In some other embodiments, the opening point of the by-pass valve would vary with the available fuel supply pressure (P_{CV})

In one embodiment, if the fuel supply pressure (P_{CV}) falls below a certain level such as about 40 bara, an alternative means of providing primary flow and recirculation flow may be required. In some embodiments, while fuel supply pressure (P_{CV}) is greater than 40 bara, they may be no parasitic load across the entire operating range. The venturi or ejector 230 may fulfill entrainment ratio requirements. In one embodiment, if the fuel supply pressure (P_{CV}) is about 700 bara, the venturi or ejector 230 in the system 400 would fulfill entrainment ratio requirements from a condition of full tank (700 bara) down to 40 bara, accounting for greater than about 92% of the fuel supply capacity. In other embodiments, when the fuel supply pressure (P_{CV}) drops to about 350 bara, the venturi or ejector 230 in the system 400 would fulfill entrainment ratio requirements from a condition of full tank (350 bara) down to 40 bar, accounting for greater than about 85% of the fuel supply capacity. In some other embodiments, when the fuel supply pressure (P_{CV}) drops to about 40 bara, the by-pass loop 224 comprising the recirculation pump or blower 220 may need to be engaged.

In one embodiment, the system 400 may be designed to protect for the fuel supply pressure (P_{CV}) of about 14 bara. In some embodiments, the venturi or ejector 230 may provide primary flow up to about 35% of the maximum current density. For example, if the maximum current density is 1.6 Amps/cm², the venturi or ejector 230 may provide primary flow up to about 0.56 Amps/cm². The by-pass loop 224 comprising the recirculation pump or blower 220 may support about 65% of the primary flow. Thus, in some embodiments, the recirculation pump or blower 220 may be sized to provide about 65% of the primary flow comprising the non-ejector system. In some embodiments, the system 400 may turn on a dashboard light such as a malfunction indicator lamp to indicate that refueling of fuel tank is required.

In one embodiment, as shown in FIG. 4B, the maximum anode inlet manifold pressure (P_{AIM}) preferred by the venturi or ejector 230 i.e. maximum ejector pressure (P_{_AIM_EJCT_MAX}) preferred by the venturi or ejector 230 as a function of current density is shown by the curve 410. In one embodiment, the system 400 may be designed such that for greater than about 85% of the operating range (in regions 480, 482), there may be no parasitic load due to fuel management recirculation (i.e. no parasitic load due to the use of the recirculation pump or blower 220). In other embodiments, the recirculation pump or blower 220) may need to be used to provide the required primary flow (in regions 484). The curve 170 shows the fraction of the recirculation flow that is delivered by the recirculation pump or blower 220, the curve 440 shows the corresponding parasitic savings, and the curve 180 shows the corresponding parasitic load.

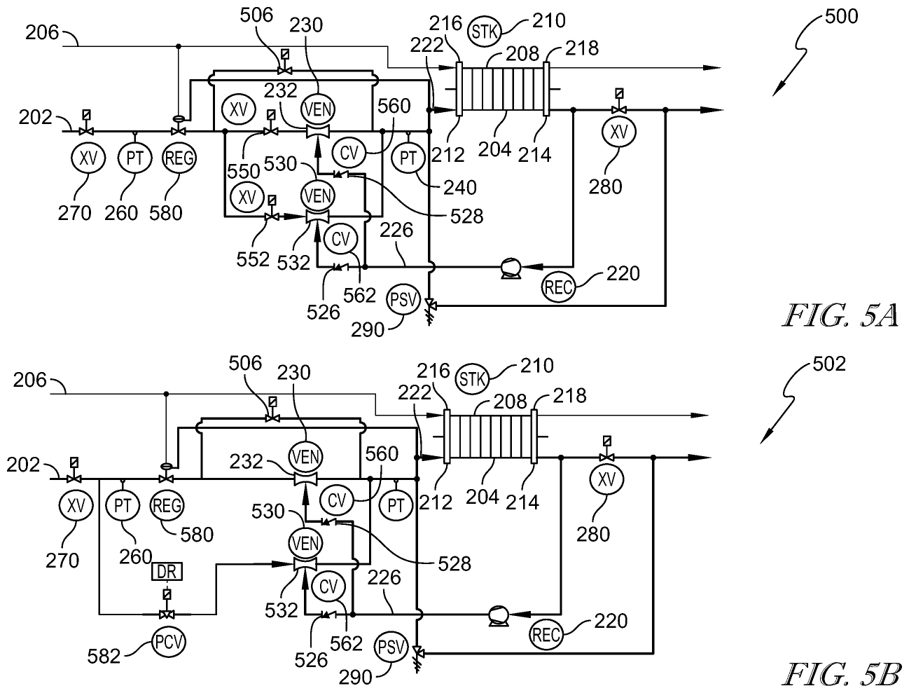

In one embodiment, as shown in FIG. 5A and FIG. 5B, the system 500/502 may have a second venturi or ejector 530 (ejector 2) in a parallel configuration with the first venturi or ejector 230 (ejector 1). In other embodiments, the system 500/502 may have one or more venturi or ejectors 530 in a parallel configuration with the first venturi or ejector 230. In some embodiments, the system 500/502 may have more than two to four venturi or ejectors 530 in a parallel configuration with the first venturi or ejector 230. In some other embodiments, the system 500/502 may have more than four venturi or ejectors 530 in a parallel configuration with the first venturi or ejector 230.

In one embodiment, as shown in FIG. 5A and FIG. 5B, the system 500/502 may have a control valve 580 upstream of the venturi or ejector 230/530. In some embodiments, the control valve 580 may be a mechanical regulator, a dome regulated mechanical regulator, a proportional control valve, or an injector.

In one embodiments, the two or more venturi or ejector 230/530 may be of the same size. In other embodiments, the two or more venturi or ejector 230/530 may be of different sizes. In some embodiments, the two or more venturi or ejector 230/530 may be sized differently to retain the overall efficiency or performance of the two or more venturi or ejector 230/530. In some embodiments, size of a venturi or ejector 230/530 may include, but is not limited to measurements related to primary nozzle flow area, internal mixer area, mixer length, suction chamber design, diffuser expansion angle and diffusion expansion length.

In one embodiment, the recirculation pump or blower 220 may be a part of the system 500/502. In some embodiments, the recirculation pump or blower 220 may be in a parallel or series configuration with the two or more venturi or ejectors 230/530. In other embodiments, the recirculation pump or blower 220 may not be a part of the system 500/502.

In one embodiment, the system 500/502 may have one or more by-pass valves. The by-pass valves may be located across one or more venturi or ejector 230/530. In one preferred embodiment, as shown in FIG. 5A and FIG. 5B, the system 500/502 may have a by-pass valve 506 downstream of the control valve 580, around the venturi or ejector 230. In some other embodiments, the system 500/502 may also have an additional by-pass valve (not shown) around the venturi or ejector 530. This configuration may not be preferred as it adds additional hardware to the system 500/502. In a further embodiment, the system 500/502 may have a by-pass valve 506 upstream of the control valve 580.

In one embodiment, as shown in FIG. 5A, the system 500/502 may engage venturi or ejector 230 or one or more venturi or ejector 530, or both venturi or ejector 230 and one or more venturi or ejector 530. In one embodiment, the transition from using one venturi or ejector 230/530 to using two or more ejectors 230/530 in the system 500 may not require more than one valve 552. In some embodiments, there may be some pressure losses in the system 500 associated with the secondary flow 226.

In one embodiment, the primary flow 202 to the two or more venturi or ejector 530/230 may be regulated by one or more valves 550/552. In some embodiments, the two or more valves 550/552 may be a proportional control valve or a mechanical regulator or a dome loaded mechanical regulator or an injector. In one embodiment, one of the two or more valves 550/552 may be a mechanical regulator. In other embodiments, one of the two or more valves 550/552 may be a proportional control valve. In other embodiments, one of the two or more valves 550/552 may be a dome loaded mechanical regulator. In some other embodiments, one of the two or more valves 550/552 may be an injector.

In one embodiment, each of the two or more venturi or ejector 230/530 has to work against the entire pressure lift of the system 500 (ΔP_{LIFT}), but is required to only lift the flow associated with the flow through primary nozzle of that respective venturi or ejector 230/530. In some embodiments, the valves regulating flow to the two or more venturi or ejector may 530/230 open and/or close to direct the primary flow 202 to the two or more venturi or ejector 530/230. In some embodiments, a part of the primary flow 202 may flow through the first of the two or more venturi or ejector 230/530, and a part of the primary flow 202 may flow through a second of the two or more venturi or ejector 230/530. In some embodiments, the primary flow 202 may be equally divided between the two or more venturi or ejector 230/530. In other embodiments, the primary flow 202 may be unequally divided between the two or more venturi or ejector 230/530

In one embodiment, a part of the secondary flow 226 may enter the venturi or ejector 230 at 232 and a part the secondary flow 226 may enter the one or more venturi or ejector 530 at 532. In some embodiments, the secondary flow 226 may not enter the venturi or ejector 230 at 232 and all of the secondary flow 226 may enter the one or more venturi or ejector 530 at 532. In other embodiments, the secondary flow 226 may not enter the one or more venturi or ejector 530 at 532 and all of the secondary flow 226 may enter the venturi or ejector 230 at 232. In some further embodiments, the secondary flow 226 through the venturi or ejector 230/530 may be regulated by check valves that prevent reverse flow 560/562.

In one embodiment, the system 500 may have two or more venturi or ejector 230/530, and may not have a recirculation pump or blower 220. In some embodiments, check valves that prevent reverse flow 560/562 may disconnect one of the two or more venturi or ejector 230/530 from the recirculation pump or blower 220. In some embodiments, the system may achieve the target entrainment ratio (ER) without requiring a recirculation pump or blower 220 and reducing parasitic loads. In other embodiments, the system may achieve the target entrainment ratio (ER) by using a smaller recirculation pump or blower 220 than what would have been required if the system 500 had only one venturi or ejector 230. In some embodiments, there may be some pressure losses in the system 500 associated with the secondary flow 226, and or the one or more valves 550/552.

In one embodiment, as shown in FIG. 5B, the system 502 may include a control valve 580 and an additional control valve 582 instead on the open close valves 550/552 ahead of the two venture or ejectors 230/530. In some embodiments, the additional control valve 582 may be a mechanical regulator, a dome regulated mechanical regulator, a proportional control valve, or an injector. In other embodiments, the control valve 582 may be equipped to completely shut off flow to the venturi or ejector 532. In some embodiments, the control valves 580 and 582 may be the same or may be different. Such a configuration provides the system 502 with an additional flexibility in controlling pressure and/or primary fuel flow as it provides the system with two separate flow control valves, each independently controlling the primary flow 202 into their respective venturi or ejectors 230/530.

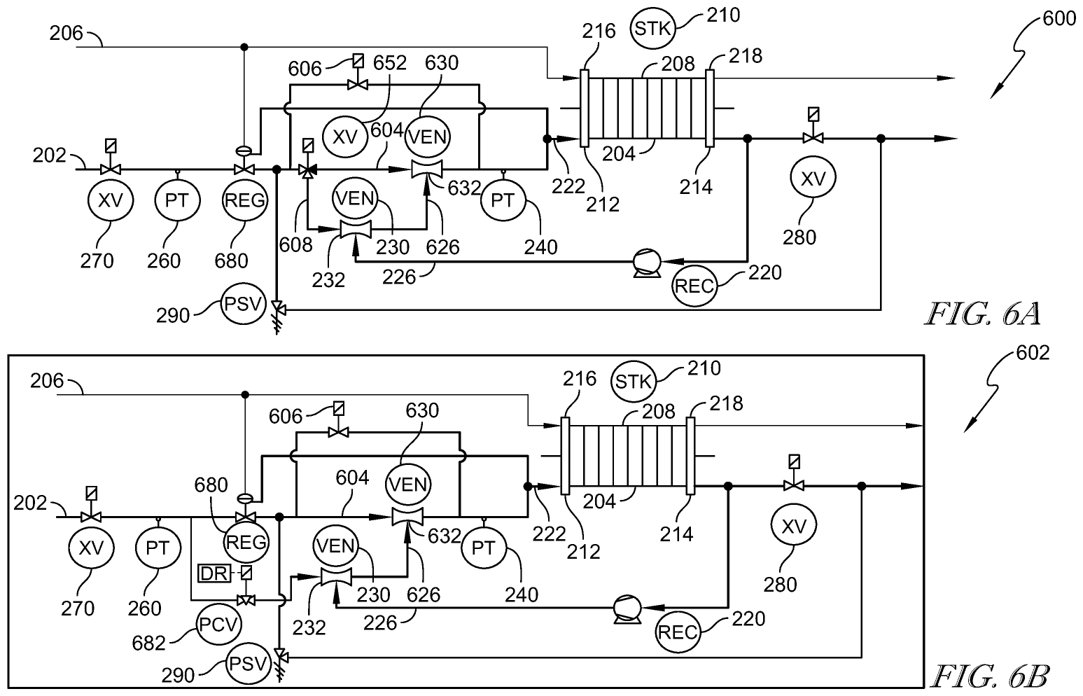

In one embodiment, as shown in FIG. 6A and FIG. 6B, the system 600/602 may have a second venturi or ejector 630 (ejector 2) in a series configuration with the first venturi or ejector 230 (ejector 1). In other embodiments, the system 600 may have one or more venturi or ejectors 630 in a series configuration with the first venturi or ejector 230. In some embodiments, the system 600 may have two to four venturi or ejectors 630 in a series configuration with the first venturi or ejector 230. In some other embodiments, the system 600 may have more than four venturi or ejectors 630 in a series configuration with the first venturi or ejector 230.

In one embodiment, as shown in FIG. 6A and FIG. 6B, the system 600/602 may have a control valve 680 upstream of the venturi or ejector 230/630. In some embodiments, the control valve 680 may be a mechanical regulator, a dome regulated mechanical regulator, a proportional control valve, or an injector.

In one embodiments, the two or more venturi or ejector 230/630 may be of the same size. In other embodiments, the two or more venturi or ejector 230/630 may be of different sizes. In some embodiments, the two or more venturi or ejector 230/530 may be sized differently to retain the overall efficiency or performance of the two or more venturi or ejector 230/530. In some embodiments, size of a venturi or ejector 230/530 may include, but is not limited to measurements related to primary nozzle flow area, internal mixer area, mixer length, suction chamber design, diffuser expansion angle and diffusion expansion length.

In one embodiment, the recirculation pump or blower 220 may be a part of the system 600/602. In some embodiments, the recirculation pump or blower 220 may be in a parallel or series configuration with the two or more venturi or ejectors 230/630. In other embodiments, the recirculation pump or blower 220 may not be a part of the system 600/602.

In one embodiment, the system 600/602 may have one or more by-pass valves. The by-pass valves may be located across one or more venturi or ejector 230/630. In one preferred embodiment, as shown in FIG. 6A and FIG. 6B, the system 600/602 may have a by-pass valve 606 downstream of the control valve 680, around the venturi or ejector 630. In some other embodiments, the system 600/602 may have an additional by-pass valve (not shown) around the venturi or ejector 230. In a further embodiment, the system 600/602 may have a by-pass valve 606 upstream of the control valve 680.

In one embodiment, the primary flow 202 to the two or more venturi or ejector 630/230 may be regulated by one valve 652. In some embodiments, the valve 652 may be a proportional control valve or a mechanical regulator or a dome loaded mechanical regulator or an injector. In other embodiments, the primary flow 202 to the two or more venturi or ejector 630/230 may be regulated by more than one valve 652. In some embodiments, the valve 652 may regulate the primary flow 202 entirely to the venturi or ejector 230. In other embodiments, the valve 652 may regulate the primary flow 202 entirely to the venturi or ejector 630. In some other embodiments, the valve 652 may regulate the primary flow 202 to be dived between the venturi or ejector 230 and one or more venturi or ejector 630.

In one embodiment, the system 600 may engage venturi or ejector 230 (solo configuration) or one or more venturi or ejector 630 (solo configuration), or both venturi or ejector 230 and one or more venturi or ejector 630 (dual configuration). In some embodiments, the transition from using one venturi or ejector 230/630 to using two or more ejectors 230/630 may not require more than one valve 652. In other embodiments, the transition from using one venturi or ejector 230/630 to using two or more ejectors 230/630 may require more than one valve 652. In some embodiments, there may be some pressure losses in the system 600 associated with the secondary flow 226.

In one embodiment, as shown in FIG. 6B, the system 602 may include a control valve 682 in additional to the control valve 680 instead of the open close valves 652 ahead of the two venturi or ejectors 230/630. In some embodiments, the additional control valve 682 may be a mechanical regulator, a dome regulated mechanical regulator, a proportional control valve, or an injector. In other embodiments, the control valve 682 may be equipped to completely shut off flow to the venturi or ejector 632. In some embodiments, the control valves 680 and 682 may be the same or may be different. Such a configuration provides the system 602 with an additional flexibility in controlling pressure and/or primary fuel flow as it provides the system with two separate flow control valves, each independently controlling the primary flow 202 into their respective venturi or ejectors 230/630.

In one embodiment, each of the two or more venturi or ejector 630 has to work against the entire pressure lift of the system 600 (ΔP_{LIFT}) if functioning in a solo configuration. In some embodiment, each of the two or more venturi or ejector 630 may not have to work against the entire pressure lift of the system 600 (ΔP_{LIFT}) if functioning in a dual or multiple configuration.

In one embodiment, in a series configuration as illustrated in FIG. 6, if both venturi or ejector 230 and venturi or ejector 630 are operational (i.e. in a dual configuration), each venturi or ejector 230/630 may need to lift the entire recirculation flow (secondary flow) 226 through a fraction of pressure lift (ΔP_{LIFT}) in the system 600/602. In some embodiments, the secondary flow 226 may enter the venturi or ejector 230 at 232. The secondary flow 626 entering the venturi or ejector 630 at 632 may comprise the secondary flow 226 and the primary flow 608 entering the venturi or ejector 230. The primary flow 604 enters the venturi or ejector 630 at 632. Thus, unlike in a parallel configuration, the additional venturi or ejector 630 has extra secondary flow because the venturi or ejector 630 has to lift the primary flow 608 from the venturi or ejector 230.

In one embodiment, the secondary flow properties of the venturi or ejector 630 may be different from the secondary flow properties of the venturi or ejector 230. In some embodiments, the secondary flow 626 through the venturi or ejector 630 may be drier and/or have a higher fuel concentration (e.g., H₂) than the secondary flow 226 through the venturi or ejector 230. In other embodiments, the secondary flow 626 through the venturi or ejector 630 may have different temperature than the secondary flow 226 through the venturi or ejector 230. In some other embodiments, the secondary flow 626 through the venturi or ejector 630 may have different density than the secondary flow 226 through the venturi or ejector 230.

In one embodiment, the one or more venturi or ejector 530/630 may be sensitive to the anode inlet manifold pressure (P_{AIM}) and/or the fuel supply pressure (P_{CV}) of the system 500/502/600/602. In some embodiment, the mixer area ratio (MAR) of the venturi or ejector 230/530 used in a parallel configuration is different than the mixer area ratio (MAR) of the venturi or ejector 230/630 used in a series configuration. In other embodiments, the mixer area ratio (MAR) of the venturi or ejector 230/530/630 is sensitive to how the venturi or ejector 230/530/630 are configured in the system 500/502/600/602.

In one embodiment, the mixer area ratio (MAR) of the venturi or ejector in a series configuration 630 may need be larger than the mixer area ratio (MAR) of the venturi or ejector in a parallel configuration 530. In one embodiment, if all else is equal, the mixer area ratio (MAR) of the venturi or ejector 230/530/630 may be a critical parameter that influences entrainment ratio (ER) vs pressure lift (ΔP_{LIFT}) capability of the system 500/502/600/602. In some embodiments, a larger mixer area ratio (MAR) enables a larger entrainment ratio (ER), but lower pressure lift (ΔP_{LIFT}) capability at the same primary nozzle flow 202.

In one embodiment, sizing of the more than one venturi or ejector 230/530 in a parallel configuration or the more than one venturi or ejector 230/630 in a series configuration is critical for determining the entrainment ratio (ER) vs pressure lift (ΔP_{LIFT}) capability of the system 500/502/600/602. In some embodiments, the factors affecting primary nozzle sizing are similar in parallel (FIG. 5) and series configuration (FIG. 6). In other embodiments, the sizing of other geometric parameters may vary between the parallel (FIG. 5) and series configuration (FIG. 6).

In one embodiment, the ratio of the primary nozzle of the venturi or ejector 230 (ejector 1) to the primary nozzle of the venturi or ejector 530/630 (ejector 2) may be equal to the ratio of the inlet diameter of the primary nozzle of the venturi or ejector 230 (ejector 1) to the inlet diameter of the of the primary nozzle of the venturi or ejector 530/630 (ejector 2). In some embodiments, the ratio of the primary nozzle of the venturi or ejector 230 (ejector 1) to the primary nozzle of the venturi or ejector 530/630 (ejector 2) may be equal to the ratio of the inlet area of the primary nozzle of the venturi or ejector 230 (ejector 1) to the inlet area of the of the primary nozzle venturi or ejector 530/630 (ejector 2). In some other embodiments, the ratio of the primary nozzle of the venturi or ejector 230 (ejector 1) to the primary nozzle of the venturi or ejector 530/630 (ejector 2) may be equal to the ratio of the outlet diameter of the of the primary nozzle of the venturi or ejector 230 (ejector 1) to the outlet diameter of the of the primary nozzle of the venturi or ejector 530/630 (ejector 2).

In one embodiment, the more than one venturi or ejector 230/530 in a parallel configuration or the more than one venturi or ejector 230/630 in a series configuration may be sized according to the minimum fuel supply pressure (P_{_CV_MIN}) for both venturi or ejectors (230 and 530 or 230 and 630). In some embodiments, the venturi or ejector 230 (ejector 1) may be sized to cover half the range of the venturi or ejector 530/630 (ejector 2). In some embodiments, the relative sizing of the venturi or ejector 230 (ejector 1) and venturi or ejector 530/630 (ejector 2) may depend on the turn down ratio of the venturi or ejectors (230 and 530 or 230 and 630). The turn down ratio ejector 230 (ejector 1) and venturi or ejector 530/630 (ejector 2) may be the same, or may be different from each other.

For example, in one embodiment, if the turn down ratio of both venturi or ejectors (230 and 530 or 230 and 630) is 2, the venturi or ejector 530/630 (ejector 1) may be sized to cover the range of about 16.7% to about 33.3% of the primary flow, and the venturi or ejector 530/630 (ejector 2) may be sized to provide about 33.3% to about 66.7% of the primary flow. Together, venturi or ejector 230 (ejector 1) and venturi or ejector 530/630 (ejector 2) may be sized to cover the range of about 66.7% to about 100% of primary flow. In other embodiments, if the turn down ratio of both venturi or ejectors (230 and 530 or 230 and 630) is 3, the venturi or ejector 530/630 (ejector 1) may be sized to cover the range of about 8.33% to about 25% of the primary flow, and the venturi or ejector 530/630 (ejector 2) may be sized to provide about 25% to about 75% of the primary flow. Together, venturi or ejector 230 (ejector 1) and venturi or ejector 530/630 (ejector 2) may be sized to cover the range of about 50% to about 100% of primary flow. In some other embodiments, if the turn down ratio of both venturi or ejectors (230 and 530 or 230 and 630) is 1.5, the venturi or ejector 530/630 (ejector 1) may be sized to cover the range of about 26.6% to about 40% of the primary flow, and the venturi or ejector 530/630 (ejector 2) may be sized to provide about 40% to about 60% of the primary flow. Together, venturi or ejector 230 (ejector 1) and venturi or ejector 530/630 (ejector 2) may be sized to cover the range of about 60% to about 100% of primary flow.

In one embodiment, the venturi or ejector 230 (ejector 1) may have a turn down ratio in the range from about 1.5 to about 8, including any ratio comprised therein. In some embodiments, the venturi or ejector 530/630 (ejector 2) may have a turn down ratio in the range from about 1.5 to about 8, including any ratio comprised therein. In some embodiments, the venturi or ejector 230 (ejector 1) and/or the venturi or ejector 530/630 (ejector 2) may be sized according to their turn down ratios. For example, if the turn down ratio of both venturi or ejectors (230 and 530 or 230 and 630) is 8, the venturi or ejector 530/630 (ejector 1) may be sized to cover the range of about 1.4% to about 11.1% of the primary flow, and the venturi or ejector 530/630 (ejector 2) may be sized to provide about 11.1% to about 89% of the primary flow.

In other embodiments, the sizing of the venturi or ejectors may depends on the number of venturi or ejectors in the system 500/502/600/602. In other embodiments, the venturi or ejector 230 (ejector 1) and the venturi or ejector 530/630 (ejector 2) may be sized to cover different ratios of the operating range of the system 500/502/600/602.

In one embodiment, the system 500/502/600/602 may have a by-pass valve 506/606 configured to account for the entrainment ratio (ER) at higher operating ranges such as above about 0.4 Amps/cm², or above about 0.6 Amps/cm², or above about 0.8 Amps/cm², or above about 1.0 Amps/cm², or above about 1.2 Amps/cm². In other embodiments, the by-pass valve 506/606 may be configured to account for the entrainment ratio (ER) at operating ranges up to the highest operating range of the system 500/502/600/602

In some embodiments, the venturi or ejector 230 (ejector 1) and the venturi or ejector 530/630 (ejector 2) may be sized to account for the entrainment ratio (ER) at operating ranges below the operating range accounted for by the by-pass valve 506/606. For example, the venturi or ejector 230 (ejector 1) and the venturi or ejector 530/630 (ejector 2) may be sized such that both the venturi or ejector 230 (ejector 1) and the venturi or ejector 530/630 (ejector 2) can together account for the entrainment ratio (ER) at operating ranges below about 0.4 Amps/cm², or below about 0.6 Amps/cm², or below about 0.8 Amps/cm², or below about 1.0 Amps/cm², or below about 1.2 Amps/cm².

In other embodiments, the venturi or ejector 230 (ejector 1) may be sized to cover half the range of the venturi or ejector 530/630 (ejector 2), such that both the venturi or ejector 230 (ejector 1) and the venturi or ejector 530/630 (ejector 2) can together account for the entrainment ratio (ER) at operating ranges below the operating range accounted for by the by-pass valve 506/606. For example, the venturi or ejector 230 (ejector 1) may be sized to cover half the range of the venturi or ejector 530/630 (ejector 2), such that both the venturi or ejector 230 (ejector 1) and the venturi or ejector 530/630 (ejector 2) can together account for the entrainment ratio (ER) at operating ranges below about 0.4 Amps/cm², or below about 0.6 Amps/cm², or below about 0.8 Amps/cm², or below about 1.0 Amps/cm², or below about 1.2 Amps/cm². In other embodiments, the venturi or ejector 230 (ejector 1) and the venturi or ejector 530/630 (ejector 2) may be sized to cover different ratios of the operating range below the operating range accounted for by the by-pass valve 506/606.

In one embodiment, the venturi or ejector 230 (ejector 1) receiving the secondary flow 226 may be sized to provide the full secondary flow 226 requirement at the lowest target operating current i.e. the excess fuel ratio current density threshold (i_{_λ_THV}) 150. In some embodiments, the lowest target operating current may be different from the excess fuel ratio current density threshold.

In one embodiment, the system 500/502/600/602 may have a by-pass valve 506/606 configured to account for the entrainment ratio (ER) at higher operating ranges such as above about 0.4 Amps/cm², or above about 0.6 Amps/cm², or above about 0.8 Amps/cm², or above about 1.0 Amps/cm², or above about 1.2 Amps/cm². The venturi or ejector 230 (ejector 1) receiving the secondary flow 226 may be sized to provide the full secondary flow 226 requirement at the lowest target operating current i.e. the excess fuel ratio current density threshold (i_{_λ_THV}) 150, and the venturi or ejector 530/630 (ejector 2) may be sized to account the operating range above the operating range accounted for by the venturi or ejector 230 (ejector 1) and below the operating range accounted for by the by-pass valve 506/606.

In one embodiment, at the lowest target operating current threshold (i_{_λ_THV}) 150, the primary nozzle inlet pressure (P_{O}_i_{_λ_THV}) is:

P_{O}_i_{_λ_THV}=P_{AIM}_i_{_λ_THV}×pr_{_CR}

P_{AIM}_i_{_λ_THV} is the anode inlet manifold pressure at the lowest target operating current threshold (i_{_λ_THV}). The critical pressure (pr_{_CR}) is ˜1.9 bara for H₂.

In one embodiment, the primary nozzle may be sized to meet maximum primary flow, including the purge flow. The primary nozzle inlet pressure in the primary nozzle sized to meet maximum primary flow, including the purge flow at the lowest target operating current threshold (i_{_λ_THV}) 150 (P_{O_CV_THV}) is:

P_{O_CV_THV}=P_{O}_i_{_λ_THV}×i_{MAX_P}/i_{_λ_THV}

The fuel supply pressure threshold (P_{_CV_THV}) is

P_{_CV_THV}=P_{O_CV_THV}×P_{_CR}

The maximum current (i_{MAX}) accounting for the purge flow is the maximum current with purge (i_{MAX_P}), given by:

i_{MAX_P}=i_{MAX}(1+prg)

The fraction of purge flow is given by prg.

In one embodiment, when the fuel supply pressure (P_{CV}) is greater than the fuel supply pressure threshold (P_{_CV_THV}), the venturi or ejector 230 (ejector 1) may provide almost 100% of the primary and recirculated flow in the system 600/602. In some embodiments, the mixer area ratio (MAR) and other parameters may be sized to enable the required entrainment ratio to be maintained across the entire operating range. In one embodiments, if lowest target operating current (i_{_λ_THV}) is 0.2 Amps/cm2, the critical pressure (pr_{_CR}) is 1.9 bara, and the anode inlet manifold pressure at the lowest target operating current P_{AIM}(i_{_λ_THV}) is 1.2 bara, the primary inlet nozzle pressure at the lowest target operating current (P_{O}(i_{_λ_THV}) is 2.28 bara. If the maximum current (i_{MAX}) is 1.6 Amps/cm², and the purge flow is 10%, the primary inlet nozzle pressure at fuel supply pressure threshold (P_{O_CV_THV}) is 20.1 bara and the fuel supply pressure threshold (P_{_CV_THV}) is 38.1 bara.

In one embodiment, the venturi or ejector 530/630 (ejector 2) may be sized to enable full primary flow requirement to be met at the fuel supply pressure threshold (P_{_CV_THV}). In one embodiment, the total effective flow area of the primary nozzles of a venturi or ejector 530/630 may be based on the maximum current at purge (i_{MAX_P}) and the fuel sizing pressure (P_{_CV_MIN}). In some embodiments, the effective flow area of the primary nozzle of the venturi or ejector 630 (ejector 2) i.e. A_{EFF_EJCT2} is:

A_{EFF_EJCT2}=A_{_EFF_TOT}−A_{EFF_EJCT1}

A_{EFF_EJCT1} is the effective flow area of the primary nozzle of the venturi or ejector 230 (ejector 1), and A_{EFF_TOT} is the total effective flow area of the primary nozzle of the venturi or ejector 230/630.

In one embodiment, if the fuel sizing pressure or the minimum control valve inlet pressure (P_{_CV_MIN}) is about 14 bara, the fraction of purge flow (prg) is 10%, P_{O}_i_{_λ_THV} the minimum primary inlet nozzle pressure needed at the lowest target operating current threshold (i_{_λ_THV}) P_{O_P}_i_{_λ_THV} is the minimum primary inlet nozzle pressure needed for purge flow at the lowest target operating current threshold (i_{_λ_THV}) 150, i_{MAX} is the maximum current of the system 500/502/600/602 i_{MAX_P} is maximum current of the system 500/502/600/602 accounting for purge flow, venturi or ejector 230 (ejector 1) and venturi or ejector 530/630 (ejector 2) may be sized as shown in Table 1.

TABLE 1

| | P_{O}_{_{—}}_{P}_{_{—}}i_{_{—}}_{λ}_{_{—}}_{THV} | A_{EFF} | i_{MAX}_{_{—}}_{P} | i_{MAX} | P_{O}_{_{—}}i_{_{—}}_{λ}_{_{—}}_{THV} |
|---|---|---|---|---|---|
| Ejector 1 | 7.37 | 1.66 | 0.65 | 0.59 | 6.70 |
| Total = | | 4.49 | 1.76 | 1.60 | |
| Ejector 2 | | 2.83 | 1.11 | 1.01 | |

In one embodiment, the system 500/502/600/602 may be configured to ensure division of labor between the venturi or ejector 230 (ejector 1) and the venturi or ejector 630/530 (ejector 2) such that the required entrainment ratio (ER) may be delivered. In some embodiments, the pressure operating curves of the system 500/502/600/602 may influence the division of labor and the switching between solo use (ejector 1 or ejector 2) and dual use. In some embodiments, the mixer area ratio (MAR) and other parameters of the venturi or ejector 230/530/630 may be sized in view of the intended operation of the system 500/600. In some embodiments, the intended operation may determine if the configuration of the venturi or ejector 230/530/630 are in series or in parallel, or if ejector 1 230 is required to operate cross the entire operating range.

In one embodiment, the ejector 1 maximum current (i_{_MAX_01}) is the maximum current that ejector 1 230 can support on its own at a given fuel supply pressure (P_{CV}) and primary inlet temperature (T_{O}). The ejector 2 maximum current (i_{_MAX_02}) is the maximum current that ejector 2 530/630 can support on its own at a given fuel supply pressure (P_{CV}) and primary inlet temperature (T_{O}). The ejector 1 minimum current (i_{_MAX_01}) is the minimum current that ejector 1 230 can support to keep ejector 1 230 choked. The ejector 2 minimum current (i_{_MIN_02}) is the minimum current that ejector 2 530/630 can support to keep ejector 2 530/630 choked. In one embodiment, the total minimum current (i_{_MIN}) is:

i_{_MIN}=i_{_MIN_01}+i_{_MIN_02}

In one embodiment, if the current demand (i_{_DEMAND}) is less than the lower of the ejector 1 minimum current (i_{_MIN_01}) and the ejector 2 minimum current (i_{_MIN_02}), primary flow 202 may go through ejector 1 230 and the system 500/502/600/602 may operate the recirculation pump or blower 220 to meet the required entrainment ratio (ER). In some embodiments, the primary flow 202 may or may not go through ejector 2 530/630.

In one embodiment, the ejector 1 maximum current (i_{_MAX_01}) is greater than the maximum current in the system 500/502/600/602 (i_{MAX}) 134, then the ejector 1 may be operated solely for any current demand (i_{_DEMAND}). In some embodiments, the ejector 1 230 may be operated solely for any current demand (i_{_DEMAND}) if

P_{CV}/√T_{O}>P_{_CV_THV}/√T_{O_MAX}

T_{O_MAX} is the maximum primary inlet temperature of the system 500/502/600/602.

In one embodiment, the ejector 1 maximum current (i_{_MAX_01}) is lesser than the maximum current in the system 500/502/600/602 (i_{MAX}) 134, then the primary flow 202 may be split between ejector 1 230 and ejector 2 530/630. In some embodiments, as the current demand (i_{_DEMAND}) increases, the system 500/502/600/602 may transition from a solo configuration using ejector 1 230 to a solo configuration using ejector 2 530/630. In other embodiments, as the current demand (i_{_DEMAND}) increases, the system 500/502/600/602 may transition from a solo configuration using ejector 1 230 or solo configuration using ejector 2 530/630 to a dual configuration using ejector 1 230 and ejector 2 530/630.

In one embodiment, the system 500/502/600/602 may not transition from using ejector 1 230 to using ejector 2 530/630 until the current in the system 500/502/600/602 reaches the ejector 2 minimum current (i_{_MIN_02}). In some embodiments, the system 500/502/600/602 may not transition away from being a solo configuration using ejector 1 230 before the current in the system 500/502/600/602 reaches the ejector 1 maximum current (i_{_MAX_01}). In other embodiments, the system 500/502/600/602 may not transition from a solo configuration to a dual configuration until the total minimum current (i_{_MIN}) is reached. In some other embodiments, the total 500/502/600/602 may transition from a solo configuration to a dual configuration before the ejector 2 maximum current (i_{_MAX_02}) is reached.

In one embodiment, the system 500/502/600/602 may operate in a solo configuration using ejector 1 230 to about 1.0 Amps/cm² when the fuel supply pressure (P_{CV}) is greater than the fuel supply pressure threshold (P_{_CV_THV}). In some embodiments, the mixer area ratio (MAR) of ejector 1 230 may be designed to the required entrainment ratio (ER) from about 0.2 Amps/cm² to about 1.0 Amps/cm². In some embodiments sizing ejector 1 maximum current density to about 1.0 Amps/cm² may allow for smaller mixing are ratio (MAR) to provide a higher pressure lift (ΔP_{LIFT}) at low flow rates. In other embodiments, a current density to about 1.0 Amps/cm² may be chosen to minimize the number of transitions the system 500/502/600/602 may have to make between different ejector configurations over system lifetime. In some other embodiments, the system 500/502/600/602 may choose to switch from a solo configuration using ejector 1 230 to a solo configuration using ejector 2 530/630. Such switching may ensure that the ejector 2 minimum current (i_{_MIN_02}) requirements are met by the system 500/502/600/602. In some other embodiments, the system 500/502/600/602 may choose to switch from a solo configuration using ejector 1 230 to a dual configuration instead of switching to a solo configuration using ejector 2 530/630.

In one embodiment, the system 500/502/600/602 may have dynamic transition points when the system 500/502/600/602 may switch from one configuration to another. In some embodiments, the system 500/502/600/602 may have a dynamic transition point when the fuel supply pressure (P_{CV}) is lower than the fuel supply pressure threshold (P_{_CV_THV}).

In one embodiment, when the fuel supply pressure (P_{CV}) is lower than the fuel supply pressure threshold (P_{_CV_THV}), and the fuel supply pressure (P_{CV}) is such that the ejector 1 maximum current (i_{_MAX_01}) is greater than or equal to about 1.1 times the total minimum current (i_{_MIN}). In some embodiments, the system 500/502/600/602 may operate in a solo configuration using ejector 1 230 when the current demand (i_{_DEMAND}) is lower than or equal to the total minimum current (i_{_MIN}). In some embodiments, the system 500/502/600/602 may transition to a dual configuration when the current demand (i_{_DEMAND}) is greater than the total minimum current (i_{_MIN}) and lower than the ejector 1 maximum current (i_{_MAX_01}).

In one embodiment, when the fuel supply pressure (P_{CV}) is lower than the fuel supply pressure threshold (P_{_CV_THV}), and the fuel supply pressure (P_{CV}) is such that the ejector 1 maximum current (i_{_MAX_01}) is lower than about 1.1 times the total minimum current (i_{_MIN}), and the ejector 1 maximum current (i_{_MAX_01}) is greater than the ejector 2 minimum current (i_{_MIN_02}). In some embodiments, the system 500/502/600/602 may operate in a solo configuration using ejector 1 230 when the current demand (i_{_DEMAND}) is lower than the ejector 2 minimum current (i_{_MIN_02}). In some embodiments, the system 500/502/600/602 may transition to a solo configuration using ejector 2 530/630 when the current demand (i_{_DEMAND}) is lower than about 0.95 times the ejector 1 maximum current (i_{_MAX_01}) and greater than the ejector 2 minimum current (i_{_MIN_02}). In some embodiments, the system 500/502/600/602 may transition from a solo configuration using ejector 2 530/630 to a dual configuration when the current demand (i_{_DEMAND}) is lower than about 0.95 times the ejector 2 maximum current (i_{_MAX_02}) and greater than the total minimum current (i_{_MIN}).

In one embodiment, the system 500/502/600/602 may have one or more static transition points when the system 500/502/600/602 may switch from one configuration to another. In some embodiments, a static transition point for the system 500/502/600/602 may be when the fuel supply pressure (P_{CV}) is lower than the fuel supply pressure threshold (P_{_CV_THV}). In some embodiments, a static transition point for the system 500/502/600/602 may be independent of the fuel supply pressure (P_{CV}).

In one embodiments, the system 500/502/600/602 may operate in solo configuration using ejector 1 230 when the current demand (i_{_DEMAND}) is lower than the ejector 2 minimum current (i_{_MIN_02}), independent of the fuel supply pressure (P_{CV}). In other embodiments, the system 500/502/600/602 may transition to a solo configuration using ejector 2 530/630 when the current demand (i_{_DEMAND}) is lower than about 0.95 times the ejector 1 maximum current (i_{_MAX_01}) and greater than the ejector 2 minimum current (i_{_MIN_02}), independent of the fuel supply pressure (P_{CV}). In some embodiments, the system 500/502/600/602 may transition from a solo configuration using ejector 2 530/630 to a dual configuration when the current demand (i_{_DEMAND}) is lower than about 0.95 times the ejector 2 maximum current (i_{_MAX_02}) and greater than the total minimum current (i_{_MIN}), independent of the fuel supply pressure (P_{CV}).

In one embodiments, when the system 500/502/600/602 may have one or more static transition points, the ejector 1 maximum current (i_{_MAX_01}) and/or the ejector 2 maximum current (i_{_MAX_02}) may be the actual current density values at a given fuel supply pressure (P_{CV}) or may be the current density values determined/evaluated/calculated at a certain fuel supply pressure (P_{_CV})such that the minimum control valve inlet pressure (P_{_CV_MIN}), the total minimum current (i_{_MIN}) and/or the ejector 2 minimum current (i_{_MIN_02}) are sensitive to √T_{O}/T_{O_MAX}. In some embodiments, the anode inlet manifold pressure (P_{AIM}) may impact the ejector 1 minimum current (i_{_MIN_01}) and/or ejector 2 minimum current (i_{_MIN_02}).

In one embodiment, one or more virtual or physical sensors may be used to estimate or determine the fuel supply pressure (P_{_CV}). In some embodiments, the estimated or measured value of the fuel supply pressure (P_{_CV}) may be correlated to the primary inlet temperature (T_{O}). In one embodiments, Schmidt trigger approach may be used to determine transitioning the system 500/502/600/602 from one ejector configuration to another. In some embodiments, using the Schmidt trigger approach may avoid oscillations between the different ejector configuration states. In other embodiments, a dashboard light may be set to fill the fuel supply tank when needing to transition between the different ejector configuration states. In some embodiments, the fuel supply pressure (P_{CV}) and/or the fuel supply pressure threshold (P_{_CV_THV}) may be correlated to √T_{O}/T_{O_MAX}.

In one embodiment, the sizing of ejector 1 230 may be optimized for the lower flow condition when using static transition points. In some embodiments, the mixer area ratio (MAR) may be set to handle the primary flow 202 and the secondary flow 226 flow at up to and including conditions when the current density in ejector 1 230 is the max current density in ejector 1 230 (i_{_MAX_1}) under minimum control valve inlet pressure (P_{_CV_MIN}) conditions. In some embodiments, minimum control valve inlet pressure (P_{_CV_MIN}) may be about 14 bara. In other embodiments, ejector 1 230 may be more robust to the pressure lift (ΔP_{LIFT}). For example, a smaller mixer area ratio (MAR) may be needed because of limited recirculation flow. In some embodiments, a smaller recirculation flow may allow for higher pressure lift (ΔP_{LIFT}), all else being equal.

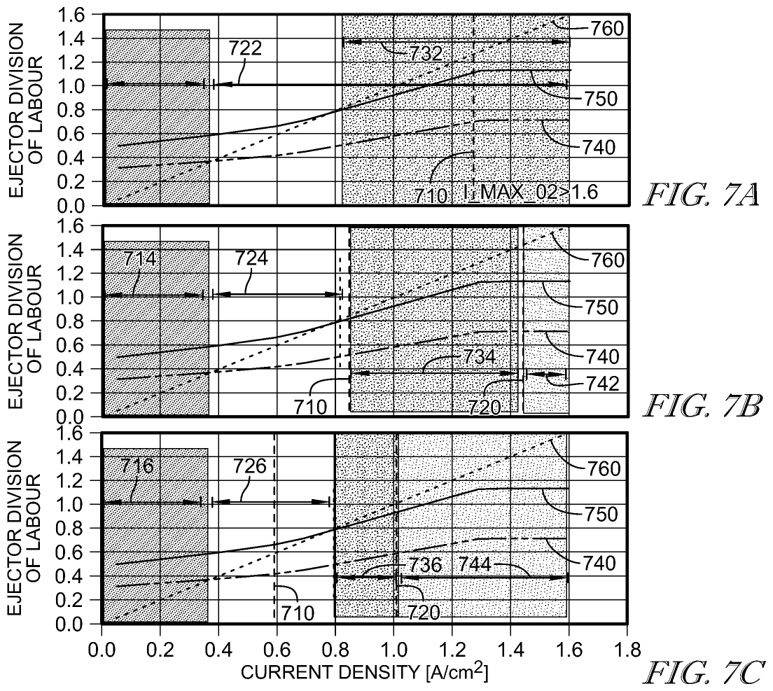

In one embodiment, as shown in FIG. 7A, if the fuel supply pressure (P_{CV}) is about 30 bara, the ejector 1 maximum current (i_{_MAX_01}) 710 may be about 1.25 Amps/cm², and the ejector 2 maximum current (i_{_MAX_02}) 720 may be greater than about 1.6 Amps/cm². In some embodiments, the system 530/630 may operate in a solo configuration using ejector 1 230 at a current demand (i_{_DEMAND}) when the ejector 2 minimum current (i_{_MIN_02}) 740 is greater than the curve 760 (region 712). In other embodiments, the system 530/630 may operate in a solo configuration using ejector 2 530/630 at a current demand (i_{_DEMAND}) when the ejector 2 minimum current (i_{_MIN_02}) 740 is lower than the curve 760 (region 722). In some other embodiments, the system 530/630 may operate in a dual configuration using ejector 1 230 and ejector 2 530/630 at a current demand (i_{_DEMAND}) when the total minimum current total (i_{_MIN}) 750 is lower than the curve 760 (region 732).

In one embodiment, as shown in FIG. 7B, if the fuel supply pressure (P_{CV}) is about 20 bara, the ejector 1 maximum current (i_{_MAX_01}) 710 may be about 0.85 Amps/cm², and the ejector 2 maximum current (i_{_MAX_02}) 720 may be about 1.45 Amps/cm². In some embodiment, the system 530/630 may operate in a solo configuration using ejector 1 230 at a current demand (i_{_DEMAND}) when the ejector 2 minimum current (i_{_MIN_02}) 740 is greater than the curve 760 (region 714). In some embodiments, the system 530/630 may operate in a solo configuration using ejector 2 530/630 at a current demand (i_{_DEMAND}) when the ejector 2 minimum current (i_{_MIN_02}) 740 is lower than the curve 760 and the total minimum current total (i_{_MIN}) 750 is greater than the curve 760 (region 724). In other embodiments, the system 530/630 may operate in a dual configuration using ejector 1 230 and ejector 2 530/630 at a current demand (i_{_DEMAND}) that is greater than the ejector 1 maximum current (i_{_MAX_01}) 710 and lower than the ejector 2 maximum current (i_{_MAX_02}) 720 (region 734). In some other embodiments, the system 530/630 may be required to operate in a dual configuration using ejector 1 230 and ejector 2 530/630 at a current demand (i_{_DEMAND}) that is greater than the ejector 2 maximum current (i_{_MAX_02}) 720 (region 742).

In one embodiment, as shown in FIG. 7C, if the fuel supply pressure (P_{CV}) is equal to the minimum control valve inlet pressure (P_{_CV_MIN}), at about 14 bara, the ejector 1 maximum current (i_{_MAX_01}) 710 may be about 0.6 Amps/cm², and the ejector 2 maximum current (i_{_MAX_02}) 720 may be about 1 Amps/cm². In some embodiments, system 530/630 may operate in a solo configuration using ejector 1 230 at a current demand (i_{_DEMAND}) when the ejector 2 minimum current (i_{_MIN_02}) 740 is greater than the curve 760 and when the current demand (i_{_DEMAND}) is lower than the ejector 1 maximum current (i_{_MAX_01}) 710 (region 716). In other embodiments, the system 530/630 may operate in a solo configuration using ejector 2 530/630 at a current demand (i_{_DEMAND}) when the ejector 2 minimum current (i_{_MIN_02}) 740 is lower than the curve 760 and the total minimum current total (i_{_MIN}) 750 is greater than the curve 760 (region 726).

In one embodiment, the system 530/630 may operate in a dual configuration using ejector 1 230 and ejector 2 530/630 at a current demand (i_{_DEMAND}) that is greater than the ejector 1 maximum current (i_{_MAX_01}) 710 and lower than the ejector 2 maximum current (i_{_MAX_02}) 720 and when the total minimum current total (i_{_MIN}) 750 is lower than the curve 760 (region 736). In some other embodiments, the system 530/630 may be required to operate in a dual configuration using ejector 1 230 and ejector 2 530/630 at a current demand (i_{_DEMAND}) that is greater than the ejector 2 maximum current (i_{_MAX_02}) 720 (region 744). In some embodiments, if the total minimum current (i_{_MIN}) 750 is less than the curve 760, the nozzles may be choked when both ejector 1 230 and ejector 2 530/630 are enabled. In some other embodiments, if the ejector 2 minimum current (i_{_MIN_02}) 740 is lower than the curve 760, the nozzles may be choked when the system 500/600 is in a solo configuration using ejector 2 530/630.

The following numbered embodiments are contemplated and are non-limiting:
1. A fuel cell stack system comprising an operating current density range comprising a lowest operating current density and a highest operating current density, a primary fuel flowing through a control valve, a first ejector comprising the first primary fuel, a first entrained fuel, a first mixer area ratio, a first maximum current density, a first minimum current density, and a first turn down ratio, and a second ejector in parallel or in series to the first ejector, comprising a second primary fuel, a second entrained fuel, a second mixer area ratio, a second maximum current density, a second minimum current density, and a second turn down ratio.
2. The fuel cell stack system of clause 1, any other suitable clause, or any combination of suitable clauses, wherein the system further comprises a blower in a series or parallel configuration to the first or the second ejector.
3. The fuel cell stack system of clause 1, any other suitable clause, or any combination of suitable clauses, wherein the first turn down ratio is from about 1.5 to about 8, or the second turn down ratio is in a range from about 1.5 to about 8, wherein the first turn down ratio is the same as the second turn down ratio.
4. The fuel cell stack system of clause 1, any other suitable clause, or any combination of suitable clauses, wherein the first turn down ratio is different from the second turn down ratio.
5. The fuel cell stack system of clause 1, any other suitable clause, or any combination of suitable clauses, wherein the first primary fuel flows through a first primary nozzle in the first ejector and the second primary fuel flows through a second primary nozzle in the second ejector, wherein first turn down ratio is 2 and the second turn down ratio is 2, and wherein the ratio of the first primary nozzle to the second primary nozzle is 2:1.
6. The fuel cell stack system of clause 1, any other suitable clause, or any combination of suitable clauses, wherein the first ejector is sized to provide an entrainment ratio at the lowest operating current density of the system up to a first current density and the second ejector is sized to provide the entrainment ratio above the first current density and up to the highest operating current density.
7. The fuel cell stack system of clause 1, any other suitable clause, or any combination of suitable clauses, wherein the system further comprises a by-pass valve downstream of the control valve and wherein the by-pass valve accounts for an entrainment ratio above a by-pass valve current density and up to the highest operating current density.
8. The fuel cell stack system of clause 7, any other suitable clause, or any combination of suitable clauses, wherein the first ejector is sized to provide the entrainment ratio at the lowest operating current density of the system up to a first current density, and the second ejector is sized to provide the entrainment ratio above the first current density and up to the by-pass valve current density.
9. The fuel cell stack system of clause 7, any other suitable clause, or any combination of suitable clauses, wherein the first primary fuel flows through a first primary nozzle in the first ejector and the second primary fuel flows through a second primary nozzle in the second ejector, wherein the first turn down ratio is 2 and the second turn down ratio is 2, wherein the ratio of the first primary nozzle to the second primary nozzle is 2:1, and wherein the first ejector and the second ejector together account for the entrainment ratio up to the by-pass valve current density.
10. The fuel cell stack system of clause 8, any other suitable clause, or any combination of suitable clauses, wherein the first primary fuel flows through a first primary nozzle in the first ejector and the second primary fuel flows through a second primary nozzle in the second ejector, the first turn down ratio is 2 and the second turn down ratio is 2, and wherein the ratio of the first primary nozzle to the second primary nozzle is 2:1.
11. The fuel cell stack system of clause 1, any other suitable clause, or any combination of suitable clauses, wherein the first mixer area ratio of the first ejector is different from the second mixer area ratio of the second ejector.
12. The fuel cell stack system of clause 1, any other suitable clause, or any combination of suitable clauses, wherein the first ejector and the second ejector are sized based on a minimum fuel supply pressure for both the first ejector and the second ejector or the turn down ratio of the first ejector and the second ejector.
13. The fuel cell stack system of clause 1, any other suitable clause, or any combination of suitable clauses, wherein the first ejector or the second ejector are sized to operate at the lowest operating current of the system.
14. The fuel cell stack system of clause 1, any other suitable clause, or any combination of suitable clauses, wherein the system operates only the first ejector if the first maximum current density of the first ejector is greater than a maximum operating current density of the system, and wherein the first mixer area ratio of the first ejector is sized to not geometrically constrain a required entrainment ratio.
15. The fuel cell stack system of clause 1, any other suitable clause, or any combination of suitable clauses, wherein the system operates the first ejector or the second ejector if the first maximum current density of the first ejector is lower than a maximum operating current density of the system.
16. The fuel cell stack system of clause 15, any other suitable clause, or any combination of suitable clauses, wherein the system operates the second ejector if current demand is equal to or more than the second minimum current density.
17. The fuel cell stack system of clause 15, any other suitable clause, or any combination of suitable clauses, wherein the system operates the second ejector before current demand is equal to the first maximum current density of the first ejector.
18. The fuel cell stack system of clause 15, any other suitable clause, or any combination of suitable clauses, wherein the system operates the first ejector and the second ejector before current demand is equal to the second maximum current density of the first ejector.
19. The fuel cell stack system of clause 1, any other suitable clause, or any combination of suitable clauses, wherein the system does not operate both the first ejector and the second ejector before current demand is equal to the sum of the first minimum current density of the first ejector and the second minimum current density of the second ejector.
20. The fuel cell stack system of clause 1, any other suitable clause, or any combination of suitable clauses, wherein the system includes two to four ejectors is series with each other or in parallel to each other.
21. The fuel cell stack system of clause 1, any other suitable clause, or any combination of suitable clauses, wherein the system includes more than four ejectors is series with each other or in parallel to each other.
22. The fuel cell stack system of clause 1, any other suitable clause, or any combination of suitable clauses, wherein the first ejector is the same size as the second ejector.
23. The fuel cell stack system of clause 1, any other suitable clause, or any combination of suitable clauses, wherein the first ejector and the second ejector are sized be sized differently to retain their overall efficiency or performance
24. The fuel cell stack system of clause 1, any other suitable clause, or any combination of suitable clauses, wherein the size of the first ejector and the second ejector include, but are is not limited to measurements related to primary nozzle flow area, internal mixer area, mixer length, suction chamber design, diffuser expansion angle and diffusion expansion length.
25. The fuel cell stack system of clause 1, any other suitable clause, or any combination of suitable clauses, wherein the system has more than on by-pass valves across more than one ejectors, or downstream of a control valve, or upstream of a control valve.
26. The fuel cell stack system of clause 25, any other suitable clause, or any combination of suitable clauses, wherein the control valve is a mechanical regulator, a dome regulated mechanical regulator, a proportional control valve, or an injector.
27. The fuel cell stack system of clause 1, any other suitable clause, or any combination of suitable clauses, wherein the system includes pressure losses associated with the first entrained flow or the second entrained flow.
28. The fuel cell stack system of clause 1, any other suitable clause, or any combination of suitable clauses, wherein the first ejector or the second ejector works against the entire pressure lift (ΔP_{LIFT}) of the system.
29. The fuel cell stack system of clause 28, any other suitable clause, or any combination of suitable clauses, wherein the first ejector or the second ejector is required to only lift the flow associated with the flow through a first primary nozzle or a second primary nozzle respectively.
30. The fuel cell stack system of clause 1, any other suitable clause, or any combination of suitable clauses, wherein one or more valves regulating flow to the first ejector and the second ejector open and/or close to direct the first primary flow to the first ejector and the second ejector.
31. The fuel cell stack system of clause 1, any other suitable clause, or any combination of suitable clauses, wherein a total primary flow is equal to the sum of the first primary flow and the second primary flow.
32. The fuel cell stack system of clause 31, any other suitable clause, or any combination of suitable clauses, wherein the total primary flow is equally divided between the first primary flow and the second primary flow.
33. The fuel cell stack system of clause 31, any other suitable clause, or any combination of suitable clauses, wherein the total primary flow is unequally divided between the first primary flow and the second primary flow.
34. The fuel cell stack system of clause 1, any other suitable clause, or any combination of suitable clauses, wherein a total entrained flow is equal to the sum of the first entrained flow and the second entrained flow.
35. The fuel cell stack system of clause 34, any other suitable clause, or any combination of suitable clauses, wherein the total entrained flow is equally divided between the first entrained flow and the second entrained flow.
36. The fuel cell stack system of clause 34, any other suitable clause, or any combination of suitable clauses, wherein the total entrained flow is unequally divided between the first entrained flow and the second entrained flow.
37. The fuel cell stack system of clause 1, any other suitable clause, or any combination of suitable clauses, wherein the first entrained flow or the second entrained flow are regulated by check valves to prevent reverse flow.
38. The fuel cell stack system of clause 1, any other suitable clause, or any combination of suitable clauses, wherein the system achieves a target entrainment ratio (ER) without requiring a blower and reducing parasitic loads.
39. The fuel cell stack system of clause 1, any other suitable clause, or any combination of suitable clauses, wherein the ejector is sized to fully deliver a recirculation without the assistance of a blower.
40. The fuel cell stack system of clause 1, any other suitable clause, or any combination of suitable clauses, wherein the first ejector and the second ejector are regulated by one valve.
41. The fuel cell stack system of clause 1, any other suitable clause, or any combination of suitable clauses, wherein the system engages the first ejector or the second ejector.
42. The fuel cell stack system of clause 1, any other suitable clause, or any combination of suitable clauses, wherein properties of the first entrained flow are different from the properties of the second entrained flow.
43. The fuel cell stack system of clause 1, any other suitable clause, or any combination of suitable clauses, wherein the first entrained flow is drier or less dry than the second entrained flow.
44. The fuel cell stack system of clause 1, any other suitable clause, or any combination of suitable clauses, wherein the first ejector or the second ejector is sensitive to the anode inlet manifold pressure (P_{AIM}) and/or the fuel supply pressure (P_{CV}) of the system.
45. The fuel cell stack system of clause 1, any other suitable clause, or any combination of suitable clauses, wherein the first mixer area ratio is different than the second mixer area ratio.
46. The fuel cell stack system of clause 1, any other suitable clause, or any combination of suitable clauses, wherein the first mixer area ratio or the second mixer area ratio is a critical parameter that influences entrainment ratio (ER) vs pressure lift (ΔP_{LIFT}) capability of the system.
47. The fuel cell stack system of clause 1, any other suitable clause, or any combination of suitable clauses, wherein a ratio of a first primary nozzle of the first ejector to a second primary nozzle of the second ejector is equal to the ratio of an inlet diameter of the first primary nozzle to an inlet diameter of the of the second primary nozzle or is equal to the ratio of an outlet diameter of the first primary nozzle to an outlet diameter of the of the second primary nozzle.
48. The fuel cell stack system of clause 1, any other suitable clause, or any combination of suitable clauses, wherein a ratio of a first primary nozzle of the first ejector to a second primary nozzle of the second ejector is equal to the ratio of an inlet area of the first primary nozzle to an inlet area of the of the second primary nozzle.
49. The fuel cell stack system of clause 1, any other suitable clause, or any combination of suitable clauses, wherein the first ejector or the second ejector are sized according to the minimum fuel supply pressure (P_{_CV_MIN}) for both the first ejector and the second ejector.
50. The fuel cell stack system of clause 1, any other suitable clause, or any combination of suitable clauses, wherein the first ejector or the second ejector are sized according to first turn down ratio or the second turn down ratio.
51. The fuel cell stack system of clause 1, any other suitable clause, or any combination of suitable clauses, wherein the first ejector or the second ejector are sized to cover different ratios of the operating range of the system.
52. The fuel cell stack system of clause 1, any other suitable clause, or any combination of suitable clauses, wherein the first ejector is sized to provide a full entrained flow requirement at an excess fuel ratio current density threshold (i_{_λ_THV}).
53. The fuel cell stack system of clause 52, any other suitable clause, or any combination of suitable clauses, wherein a primary nozzle inlet pressure (P_{O}_i_{_λ_THV} ) is:

P_{O}_i_{_λ_THV}=P_{AIM}_i_{_λ_THV}×pr_{_CR}
54. The fuel cell stack system of clause 1, any other suitable clause, or any combination of suitable clauses, wherein a total effective flow area of a primary nozzle of the first ejector or the second ejector is based on a maximum current at purge (i_{_MAX_P}) and a fuel sizing pressure (P_{_CV_MIN}).
55. The fuel cell stack system of clause 1, any other suitable clause, or any combination of suitable clauses, wherein pressure operating curves of the system influence a division of labor and switching between solo use and dual use of the first ejector and the second ejector.
56. The fuel cell stack system of clause 1, any other suitable clause, or any combination of suitable clauses, wherein a first ejector maximum current (i_{_MAX_01}) is a maximum current that the first ejector can support on its own at a given fuel supply pressure (P_{CV}) and primary inlet temperature (T_{O}).
57. The fuel cell stack system of clause 1, any other suitable clause, or any combination of suitable clauses, wherein a second ejector minimum current (i_{_MIN_02}) is a minimum current that the second ejector can support to keep the second ejector choked.
58. A method of operating a fuel cell stack system comprising:
   flowing a first primary fuel through a control valve and a first ejector,
   flowing a first entrained fuel through the first ejector,
   flowing a second primary fuel through the control valve and a second ejector which is in parallel or in series to the first ejector,
   flowing a second entrained fuel through the second ejector, and
   operating the first or the second ejector,
   wherein the first ejector comprises a first maximum current density, a first turn down ratio, a first mixer area ratio, and a first minimum current density, wherein the second ejector comprises a second maximum current density, a second turn down ratio, a second mixer area ratio, and a second minimum current density, and wherein the system comprises an operating current density range comprising a lowest operating current density and a highest operating current density.
59. The method of clause 58, any other suitable clause, or any combination of suitable clauses, wherein the system further comprises a blower in a series or parallel configuration to the first or the second ejector.
60. The method of clause 58, any other suitable clause, or any combination of suitable clauses, wherein the first turn down ratio is from about 1.5 to about 8, or the second turn down ratio is in a range from about 1.5 to about 8, wherein the first turn down ratio is the same as the second turn down ratio.
61. The method of clause 58, any other suitable clause, or any combination of suitable clauses, wherein the first turn down ratio is different from the second turn down ratio.
62. The method of clause 58, any other suitable clause, or any combination of suitable clauses, wherein the first primary fuel flows through a first primary nozzle in the first ejector and the second primary fuel flows through a second primary nozzle in the second ejector, wherein first turn down ratio is 2 and the second turn down ratio is 2, and wherein the ratio of the first primary nozzle to the second primary nozzle is 2:1.
63. The method of clause 58, any other suitable clause, or any combination of suitable clauses, wherein the first ejector is sized to provide an entrainment ratio at the lowest operating current density of the system up to a first current density and the second ejector is sized to provide the entrainment ratio above the first current density and up to the highest operating current density.
64. The method of clause 58, any other suitable clause, or any combination of suitable clauses, wherein the system further comprises a by-pass valve downstream of the control valve and wherein the by-pass valve accounts for an entrainment ratio above a by-pass valve current density and up to the highest operating current density.
65. The method of clause 64, any other suitable clause, or any combination of suitable clauses, wherein the first ejector is sized to provide the entrainment ratio at the lowest operating current density of the system up to a first current density, and the second ejector is sized to provide the entrainment ratio above the first current density and up to the by-pass valve current density.
66. The method of clause 64, any other suitable clause, or any combination of suitable clauses, wherein the first primary fuel flows through a first primary nozzle in the first ejector and the second primary fuel flows through a second primary nozzle in the second ejector, wherein the first turn down ratio is 2 and the second turn down ratio is 2, wherein the ratio of the first primary nozzle to the second primary nozzle is 2:1, and wherein the first ejector and the second ejector together account for the entrainment ratio up to the by-pass valve current density.
67. The method of clause 65, any other suitable clause, or any combination of suitable clauses, wherein the first primary fuel flows through a first primary nozzle in the first ejector and the second primary fuel flows through a second primary nozzle in the second ejector, the first turn down ratio is 2 and the second turn down ratio is 2, and wherein the ratio of the first primary nozzle to the second primary nozzle is 2:1.
68. The method of clause 58, any other suitable clause, or any combination of suitable clauses, wherein the first mixer area ratio of the first ejector is different from the second mixer area ratio of the second ejector.
69. The method of clause 58, any other suitable clause, or any combination of suitable clauses, wherein the first ejector and the second ejector are sized based on a minimum fuel supply pressure for both the first ejector and the second ejector or the turn down ratio of the first ejector and the second ejector.
70. The method of clause 58, any other suitable clause, or any combination of suitable clauses, wherein the first ejector or the second ejector are sized to operate at the lowest operating current of the system.
71. The method of clause 58, any other suitable clause, or any combination of suitable clauses, wherein the system operates only the first ejector if the first maximum current density of the first ejector is greater than a maximum operating current density of the system, and wherein the first mixer area ratio of the first ejector is sized to not geometrically constrain a required entrainment ratio.
72. The method of clause 58, any other suitable clause, or any combination of suitable clauses, wherein the system operates the first ejector or the second ejector if the first maximum current density of the first ejector is lower than a maximum operating current density of the system.
73. The method of clause 58, any other suitable clause, or any combination of suitable clauses, wherein the system operates the second ejector if current demand is equal to or more than the second minimum current density.
74. The method of clause 58, any other suitable clause, or any combination of suitable clauses, wherein the system operates the second ejector before current demand is equal to the first maximum current density of the first ejector.
75. The method of clause 58, any other suitable clause, or any combination of suitable clauses, wherein the system operates the first ejector and the second ejector before current demand is equal to the second maximum current density of the first ejector.
76. The method of clause 58, any other suitable clause, or any combination of suitable clauses, wherein the system does not operate both the first ejector and the second ejector before current demand is equal to the sum of the first minimum current density of the first ejector and the second minimum current density of the second ejector.
77. The method of clause 58, any other suitable clause, or any combination of suitable clauses, wherein the system includes two to four ejectors is series with each other or in parallel to each other.
78. The method of clause 58, any other suitable clause, or any combination of suitable clauses, wherein the system includes more than four ejectors is series with each other or in parallel to each other.
79. The method of clause 58, any other suitable clause, or any combination of suitable clauses, wherein first ejector is the same size as the second ejector.
80. The method of clause 58, any other suitable clause, or any combination of suitable clauses, wherein the first ejector and the second ejector are sized be sized differently to retain their overall efficiency or performance.
81. The method of clause 58, any other suitable clause, or any combination of suitable clauses, wherein the size of the first ejector and the second ejector include, but are is not limited to measurements related to primary nozzle flow area, internal mixer area, mixer length, suction chamber design, diffuser expansion angle and diffusion expansion length.
82. The method of clause 58, any other suitable clause, or any combination of suitable clauses, wherein the system has more than on by-pass valves across more than one ejectors, or downstream of a control valve, or upstream of a control valve.
83. The method of clause 82, any other suitable clause, or any combination of suitable clauses, wherein the control valve is a mechanical regulator, a dome regulated mechanical regulator, a proportional control valve, or an injector.
84. The method of clause 58, any other suitable clause, or any combination of suitable clauses, wherein the system includes pressure losses associated with the first entrained flow or the second entrained flow.
85. The method of clause 58, any other suitable clause, or any combination of suitable clauses, wherein the first ejector or the second ejector works against the entire pressure lift (ΔP_{LIFT}) of the system.
86. The method of clause 85, any other suitable clause, or any combination of suitable clauses, wherein the first ejector or the second ejector is required to only lift the flow associated with the flow through a first primary nozzle or a second primary nozzle respectively.
87. The method of clause 58, any other suitable clause, or any combination of suitable clauses, wherein one or more valves regulating flow to the first ejector and the second ejector open and/or close to direct the first primary flow to the first ejector and the second ejector.
88. The method of clause 58, any other suitable clause, or any combination of suitable clauses, wherein a total primary flow is equal to the sum of the first primary flow and the second primary flow.
89. The method of clause 88, any other suitable clause, or any combination of suitable clauses, wherein the total primary flow is equally divided between the first primary flow and the second primary flow.
90. The method of clause 88, any other suitable clause, or any combination of suitable clauses, wherein the total primary flow is unequally divided between the first primary flow and the second primary flow.
91. The method of clause 58, any other suitable clause, or any combination of suitable clauses, wherein a total entrained flow is equal to the sum of the first entrained flow and the second entrained flow.
92. The method of clause 91, any other suitable clause, or any combination of suitable clauses, wherein the total entrained flow is equally divided between the first entrained flow and the second entrained flow.
93. The method of clause 91, any other suitable clause, or any combination of suitable clauses, wherein the total entrained flow is unequally divided between the first entrained flow and the second entrained flow.
94. The method of clause 58, any other suitable clause, or any combination of suitable clauses, wherein the first entrained flow or the second entrained flow are regulated by check valves to prevent reverse flow.
95. The method of clause 58, any other suitable clause, or any combination of suitable clauses, wherein the system achieves a target entrainment ratio (ER) without requiring a blower and reducing parasitic loads.
96. The method of clause 58, any other suitable clause, or any combination of suitable clauses, wherein the ejector is sized to fully deliver a recirculation without the assistance of a blower.
97. The method of clause 58, any other suitable clause, or any combination of suitable clauses, wherein the first ejector and the second ejector are regulated by one valve.
98. The method of clause 58, any other suitable clause, or any combination of suitable clauses, wherein the system engages the first ejector or the second ejector.
99. The method of clause 58, any other suitable clause, or any combination of suitable clauses, wherein properties of the first entrained flow are different from the properties of the second entrained flow.
100. The method of clause 58, any other suitable clause, or any combination of suitable clauses, wherein the first entrained flow is drier or less dry than the second entrained flow.
101. The method of clause 58, any other suitable clause, or any combination of suitable clauses, wherein the first ejector or the second ejector is sensitive to the anode inlet manifold pressure (P_{AIM}) and/or the fuel supply pressure (P_{CV}) of the system.
102. The method of clause 58, any other suitable clause, or any combination of suitable clauses, wherein the first mixer area ratio is different than the second mixer area ratio.
103. The method of clause 58, any other suitable clause, or any combination of suitable clauses, wherein the first mixer area ratio or the second mixer area ratio is a critical parameter that influences entrainment ratio (ER) vs pressure lift (ΔP_{LIFT}) capability of the system.
104. The method of clause 58, any other suitable clause, or any combination of suitable clauses, wherein a ratio of a first primary nozzle of the first ejector to a second primary nozzle of the second ejector is equal to the ratio of an inlet diameter of the first primary nozzle to an inlet diameter of the of the second primary nozzle or is equal to the ratio of an outlet diameter of the first primary nozzle to an outlet diameter of the of the second primary nozzle.
105. The method of clause 58, any other suitable clause, or any combination of suitable clauses, wherein a ratio of a first primary nozzle of the first ejector to a second primary nozzle of the second ejector is equal to the ratio of an inlet area of the first primary nozzle to an inlet area of the of the second primary nozzle.
106. The method of clause 58, any other suitable clause, or any combination of suitable clauses, wherein the first ejector or the second ejector are sized according to the minimum fuel supply pressure (P_{_CV_MIN}) for both the first ejector and the second ejector.
107. The method of clause 58, any other suitable clause, or any combination of suitable clauses, wherein the first ejector or the second ejector are sized according to first turn down ratio or the second turn down ratio.
108. The method of clause 58, any other suitable clause, or any combination of suitable clauses, wherein the first ejector or the second ejector are sized to cover different ratios of the operating range of the system.
109. The method of clause 58, any other suitable clause, or any combination of suitable clauses, wherein the first ejector is sized to provide a full entrained flow requirement at an excess fuel ratio current density threshold (i_{_λ_THV}).
110. The method of clause 109, any other suitable clause, or any combination of suitable clauses, wherein a primary nozzle inlet pressure (P_{O}_i_{_λ_THV}) is:

P_{O}_i_{_λ_THV}=P_{AIM}_i_{_λ_THV}×pr_{_CR}
111. The method of clause 58, any other suitable clause, or any combination of suitable clauses, wherein a total effective flow area of a primary nozzle of the first ejector or the second ejector is based on a maximum current at purge (i_{_MAX_P}) and a fuel sizing pressure (P_{_CV_MIN}).
112. The method of clause 58, any other suitable clause, or any combination of suitable clauses, wherein pressure operating curves of the system influence a division of labor and switching between solo use and dual use of the first ejector and the second ejector.
113. The method of clause 58, any other suitable clause, or any combination of suitable clauses, wherein a first ejector maximum current (i_{_MAX_01}) is a maximum current that the first ejector can support on its own at a given fuel supply pressure (P_{CV}) and primary inlet temperature (T_{O}).
114. The method of clause 58, any other suitable clause, or any combination of suitable clauses, wherein a second ejector minimum current (i_{_MIN_02}) is a minimum current that the second ejector can support to keep the second ejector choked.

The features illustrated or described in connection with one exemplary embodiment may be combined with any other feature or element of any other embodiment described herein. Such modifications and variations are intended to be included within the scope of the present disclosure. Further, a person skilled in the art will recognize that terms commonly known to those skilled in the art may be used interchangeably herein.

As used herein, an element or step recited in the singular and proceeded with the word “a” or “an” should be understood as not excluding plural of said elements or steps, unless such exclusion is explicitly stated. Furthermore, references to “one embodiment” of the presently described subject matter are not intended to be interpreted as excluding the existence of additional embodiments that also incorporate the recited features. Specified numerical ranges of units, measurements, and/or values comprise, consist essentially or, or consist of all the numerical values, units, measurements, and/or ranges including or within those ranges and/or endpoints, whether those numerical values, units, measurements, and/or ranges are explicitly specified in the present disclosure or not.

Unless defined otherwise, technical and scientific terms used herein have the same meaning as is commonly understood by one of ordinary skill in the art to which this disclosure belongs. The terms “first,” “second,” “third” and the like, as used herein do not denote any order or importance, but rather are used to distinguish one element from another. The term “or” is meant to be inclusive and mean either or all of the listed items. In addition, the terms “connected” and “coupled” are not restricted to physical or mechanical connections or couplings, and can include electrical connections or couplings, whether direct or indirect.

Moreover, unless explicitly stated to the contrary, embodiments “comprising,” “including,” or “having” an element or a plurality of elements having a particular property may include additional such elements not having that property. The term “comprising” or “comprises” refers to a composition, compound, formulation, or method that is inclusive and does not exclude additional elements, components, and/or method steps. The term “comprising” also refers to a composition, compound, formulation, or method embodiment of the present disclosure that is inclusive and does not exclude additional elements, components, or method steps.

The phrase “consisting of” or “consists of” refers to a compound, composition, formulation, or method that excludes the presence of any additional elements, components, or method steps. The term “consisting of” also refers to a compound, composition, formulation, or method of the present disclosure that excludes the presence of any additional elements, components, or method steps.

The phrase “consisting essentially of” or “consists essentially of” refers to a composition, compound, formulation, or method that is inclusive of additional elements, components, or method steps that do not materially affect the characteristic(s) of the composition, compound, formulation, or method. The phrase “consisting essentially of” also refers to a composition, compound, formulation, or method of the present disclosure that is inclusive of additional elements, components, or method steps that do not materially affect the characteristic(s) of the composition, compound, formulation, or method steps.

Approximating language, as used herein throughout the specification and claims, may be applied to modify any quantitative representation that could permissibly vary without resulting in a change in the basic function to which it is related. Accordingly, a value modified by a term or terms, such as “about”, and “substantially” is not to be limited to the precise value specified. In some instances, the approximating language may correspond to the precision of an instrument for measuring the value. Here and throughout the specification and claims, range limitations may be combined and/or interchanged. Such ranges are identified and include all the sub-ranges contained therein unless context or language indicates otherwise.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable.

It is to be understood that the above description is intended to be illustrative, and not restrictive. For example, the above-described embodiments (and/or aspects thereof) may be used individually, together, or in combination with each other. In addition, many modifications may be made to adapt a particular situation or material to the teachings of the subject matter set forth herein without departing from its scope. While the dimensions and types of materials described herein are intended to define the parameters of the disclosed subject matter, they are by no means limiting and are exemplary embodiments. Many other embodiments will be apparent to those of skill in the art upon reviewing the above description. The scope of the subject matter described herein should, therefore, be determined with reference to the appended claims, along with the full scope of equivalents to which such claims are entitled.

This written description uses examples to disclose several embodiments of the subject matter set forth herein, including the best mode, and also to enable a person of ordinary skill in the art to practice the embodiments of disclosed subject matter, including making and using the devices or systems and performing the methods. The patentable scope of the subject matter described herein is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

While only certain features of the invention have been illustrated and described herein, many modifications and changes will occur to those skilled in the art. It is, therefore, to be understood that the appended claims are intended to cover all such modifications and changes as fall within the true spirit of the invention.

What is claimed is:

1. A fuel cell or fuel stack system comprising:
an operating current density range comprising a lowest operating current density and a highest operating current density,
a primary fuel flowing through a control valve,
a first ejector comprising the first primary fuel, a first entrained fuel, a first mixer area ratio, a first maximum current density, a first minimum current density, and a first turn down ratio, and
a second ejector in parallel or in series to the first ejector, comprising a second primary fuel, a second entrained fuel, a second mixer area ratio, a second maximum current density, a second minimum current density, and a second turn down ratio.

2. The system of claim 1, wherein the system further comprises a blower in a series or parallel configuration to the first or the second ejector.

3. The system of claim 1, wherein the first turn down ratio is from about 1.5 to about 8, or the second turn down ratio is in a range from about 1.5 to about 8, wherein the first turn down ratio is the same as the second turn down ratio.

4. The system of claim 1, wherein the first turn down ratio is different from the second turn down ratio.

5. The system of claim 1, wherein the first primary fuel flows through a first primary nozzle in the first ejector and the second primary fuel flows through a second primary nozzle in the second ejector, wherein first turn down ratio is 2 and the second turn down ratio is 2, and wherein the ratio of the first primary nozzle to the second primary nozzle is 2:1.

6. The system of claim 1, wherein the first ejector is sized to provide an entrainment ratio at the lowest operating current density of the system up to a first current density and the second ejector is sized to provide the entrainment ratio above the first current density and up to the highest operating current density.

7. The system of claim 1, wherein the system further comprises a by-pass valve downstream of the control valve and wherein the by-pass valve accounts for an entrainment ratio above a by-pass valve current density and up to the highest operating current density.

8. The system of claim 7, wherein the first ejector is sized to provide the entrainment ratio at the lowest operating current density of the system up to a first current density, and the second ejector is sized to provide the entrainment ratio above the first current density and up to the by-pass valve current density.

9. The system of claim 7, wherein the first primary fuel flows through a first primary nozzle in the first ejector and the second primary fuel flows through a second primary nozzle in the second ejector, wherein the first turn down ratio is 2 and the second turn down ratio is 2, wherein the ratio of the first primary nozzle to the second primary nozzle is 2:1, and wherein the first ejector and the second ejector together account for the entrainment ratio up to the by-pass valve current density.

10. The system of claim 8, wherein the first primary fuel flows through a first primary nozzle in the first ejector and the second primary fuel flows through a second primary nozzle in the second ejector, the first turn down ratio is 2 and the second turn down ratio is 2, and wherein the ratio of the first primary nozzle to the second primary nozzle is 2:1.

11. The system of claim 1, wherein the first ejector and the second ejector are sized based on a minimum fuel supply pressure for both the first ejector and the second ejector or the turn down ratio of the first ejector and the second ejector.

12. The system of claim 1, wherein the first ejector or the second ejector are sized to operate at the lowest operating current of the system.

13. The system of claim 1, wherein the system operates only the first ejector if the first maximum current density of the first ejector is greater than a maximum operating current density of the system, and wherein the first mixer area ratio of the first ejector is sized to not geometrically constrain a required entrainment ratio.

14. The system of claim 1, wherein the system operates the first ejector or the second ejector if the first maximum current density of the first ejector is lower than a maximum operating current density of the system.

15. The system of claim 15, wherein the system operates the second ejector if current demand is equal to or more than the second minimum current density or wherein the system operates the second ejector before current demand is equal to the first maximum current density of the first ejector.

16. A method of operating a fuel cell stack system comprising:
flowing a first primary fuel through a control valve and a first ejector,
flowing a first entrained fuel through the first ejector,
flowing a second primary fuel through the control valve and a second ejector which is in parallel or in series to the first ejector,
flowing a second entrained fuel through the second ejector, and
operating the first or the second ejector,
wherein the first ejector comprises a first maximum current density, a first turn down ratio, a first mixer area ratio, and a first minimum current density,
wherein the second ejector comprises a second maximum current density, a second turn down ratio, a second mixer area ratio, and a second minimum current density, and
wherein the system comprises an operating current density range comprising a lowest operating current density and a highest operating current density.

17. The method of claim 16, wherein the system further comprises a blower in a series or parallel configuration to the first or the second ejector.

18. The method of claim 16, wherein the first turn down ratio is from about 1.5 to about 8, or the second turn down ratio is in a range from about 1.5 to about 8, wherein the first turn down ratio is the same as the second turn down ratio.

19. The method of claim 16, wherein the first turn down ratio is different from the second turn down ratio.

20. The method of claim 16, wherein the first primary fuel flows through a first primary nozzle in the first ejector and the second primary fuel flows through a second primary nozzle in the second ejector, wherein first turn down ratio is 2 and the second turn down ratio is 2, and wherein the ratio of the first primary nozzle to the second primary nozzle is 2:1.
